(19) United States
(12) Patent Application Publication
(10) Pub. No.: US 2016/0097022 A1
(43) Pub. Date: Apr. 7, 2016

(54) Enzyme Solubility in Liquid Detergent and Use of Detergent Composition

(71) Applicant: NOVOZYMES A/S, Bagsvaerd (DK)

(72) Inventor: Lise Munch Mikkelsen, Roedvre (DK)

(73) Assignee: Novozymes A/S, Bagsvaerd (DK)

(21) Appl. No.: 14/781,211

(22) PCT Filed: Apr. 4, 2014
(86) PCT No.: PCT/EP2014/056864

§ 371 Date: Sep. 29, 2015

(30) Foreign Application Priority Data
Apr. 5, 2013 (EP) 13162450.4

(51) Int. Cl. C11D 3/386; C11D 1/22; C11D 17/04; C11D 1/29; C11D 3/43

(52) U.S. Cl. CPC C11D 3/38627; C11D 3/38618; C11D 1/29; C11D 3/43; C11D 17/043; C11D 17/045; C11D 1/22

(57) ABSTRACT

The present invention concerns a method for increasing the solubility of an enzyme in a liquid detergent composition comprising one or more enzymes, an anionic surfactant and a solvent system, which liquid detergent composition has a Hansen Solubility Parameter hydrogen bonding contribution (δh) in the range of 2-35. In addition, the invention concerns a liquid detergent composition and use of the detergent composition.

### REFERENCE TO A SEQUENCE LISTING

This application contains a Sequence Listing in computer readable form. The computer readable form is incorporated herein by reference.

### FIELD OF THE INVENTION

The present invention concerns a method for increasing the solubility of an enzyme in an liquid detergent, a liquid detergent comprising an enzyme, use of the detergent for removing stains and a textile or item washed with the detergent composition.

### BACKGROUND OF THE INVENTION

On a global basis, liquid detergents are gradually taking market share from powders and have obtained a very strong market position especially in the US. The main features of liquids that consumers find attractive are rapid dissolution at low temperatures and the convenience of prespotting. Further, the visible appearance of the liquid product can be important to the consumer.

Detergent products in unit dose form have become one of the preferred forms for the consumer due to the easiness of use, in particular liquid detergent pouches, which in addition to the easy dosing process the same advantages of the liquid detergent.

Liquid detergents can be produced with much simpler equipment and with less energy consumption than powders. On the other hand, they are more difficult to formulate because the ingredients eg. enzymes may interact directly with each other or dissolving the enzyme in the detergent may be difficult. Liquid unit dose detergents are typically wrapped in a water soluble film, which again possess an additional formulation challenge since the water content should be low in order not to dissolve the film from the inside.

International patent application WO2011/073062 concerns a bi-continuous micro-emulsion detergent composition which removes soil and/or stains of solid or solidified fatty material in the main wash at neutral pH.

WO2012/041774 relates to a detergent composition for use in laundry.

The present invention overcomes the problems of the prior art detergents.

### SUMMARY OF THE INVENTION

The present invention concerns a method for increasing the solubility of an enzyme in a liquid detergent composition comprising one or more enzymes, an anionic surfactant and a solvent system, which liquid detergent composition has a Hansen Solubility Parameter hydrogen bonding contribution (δh) in the range of 2-35.

The invention further concerns a liquid detergent composition comprising one or more enzymes, an anionic surfactant and a solvent system, which liquid detergent composition has a Hansen Solubility Parameter hydrogen bonding contribution (δh) in the range of 2-35.

The invention further concerns a detergent multi-compartment pouch having a plurality of water-soluble films forming a plurality of compartments the pouch comprising two or three side-by-side compartments superposed onto another compartment wherein at least two different compartments contain two different compositions, which multi-compartment pouch comprises the liquid detergent composition of the invention or the compartments can be linked side-by-side.

Additionally, the invention concerns a the use of a detergent composition of the invention for removing or releasing a stain from a textile having a stain and a textile washed with the detergent of the invention.

### DEFINITIONS

Alpha-Amylases (alpha-1,4-glucan-4-glucanohydrolases, E.C. 3.2.1.1) constitute a group of enzymes, which catalyze hydrolysis of starch and other linear and branched 1,4-glucosidic oligo- and polysaccharides. Alpha-amylases are known derived from a wide selection of organisms including Bacteria, such as from species of the genus Bacillus e.g. Bacillus licheniformis; from species of fungi, such as Aspergillus oryzae (TAKA-amylase) or Aspergillus niger; from plants such as barley and from mammals.

Delta remission value (ΔRem): The terms “Delta remission” or “Delta remission value” are defined herein as the result of a reflectance or remission measurement at a certain wavelength which typically is 460 nm. The swatch is measured with one swatch of similar colour as background, preferably a swatch from a repetition wash. A swatch representing each swatch type is measured before the wash. The Delta remission is the remission value of the washed swatch minus the remission value of the unwashed swatch.

Dish washing composition: The term “dish washing composition” refers to compostions intended for cleaning dishes, table ware, pots, pans, cutlery and all forms of compositions for cleaning hard surfaces areas in kitchens. The present invention is not restricted to any particular type of dish wash composition or any particular detergent.

Enzyme Detergency benefit: The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides. Adecuate amounts of enzymes is determined by the desired detergency and is typically in the range of 1-5000 ppm (active enzyme) in detergent for each relevant enzyme.

Hard surface cleaning: The term “Hard surface cleaning” is defined herein as cleaning of hard surfaces wherein hard surfaces may include floors, tables, walls, roofs etc. as well as surfaces of hard objects such as cars (car wash) and dishes (dish wash). Dish washing includes but are not limited to cleaning of plates, cups, glasses, bowls, cutlery such as spoons, knives, forks, serving utensils, ceramics, plastics, metals, china, glass and acrylics.

Hansen Solubility: The term Hansen solubility is explained below. The composition of the present invention comprises both surfactants, a solvent system, one or more enzymes, optionally builders and salts, bases used for pH adjustments, and optionally other detergent ingredients.

Achieving adecuate solubility of any compound in a solvent mix, the polarity of the compound must be within a certain range compared to the polarity of the overall solvent mix. As a measure of polarity the Hansen Solubility parameter approach is used.

Hansen Solubility is a well known and calculated parameter based on a three component measuring system for detergents (US 2012/0175797). Hansen Solubility is based on a dispersion force component (δd), a hydrogen bonding component (δh) and a polar component (δp). The Hansen Solubility (δ) is derived from the total cohesive energy, which is the energy required to break all the cohesive bonds, is the combination of the dispersion forces (d), the molecular dipole forces (p) and the hydrogen bonding forces (h) according to the following equation:

δ²=δ_{d}²+δₚ²+δₕ²

δ is achieved by finding the square root of δ².

Hansen Solubility can either be measured experimentally by dissolving in a large range of well known solvents (ex by Agfa labs) or for smaller molecules is calculated at 25° C., with HSPiP software version 4.0.03 or used the library values in the software data package which uses an unpublished proprietary algorithm that is based on values published in the Handbook of solubility Parameters and other parameters by Allan F M Barton (CRC Press 1983) for solvents obtained experimentally by Hansen.

Lipase: The terms “lipase”, “lipase enzyme”, “lipolytic enzyme”, “lipid esterase”, “lipolytic polypeptide”, and “lipolytic protein” refers to an enzyme in class EC3.1,1 as defined by Enzyme Nomenclature. It may have lipase activity (triacylglycerol lipase, EC3.1.1.3), cutinase activity (EC3.1.1.74), sterol esterase activity (EC3.1.1.13) and/or wax-ester hydrolase activity (EC3.1.1.50). For purposes of the present invention, lipase activity is determined according to the procedure described in the Examples. In one aspect, the variants of the present invention have at least 20%, e.g., at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or 100% of the lipase activity of the polypeptide of SEQ ID NO: 2.

Parent or parent enzyme: The term “parent” or “parent enzyme” means an enzyme to which an alteration is made to produce the enzyme variants of the present invention. The parent may be a naturally occurring (wild-type) polypeptide or a variant or fragment thereof.

Proteases are enzymes cleaving the amide linkages in protein substrates are classified as proteases, or (interchangeably) peptidases (see Walsh, 1979, Enzymatic Reaction Mechanisms. W.H. Freeman and Company, San Francisco, Chapter 3).

Solvent system; The solvent system is defined as all solvents used to dissolve the surfactants in the unit dose composition, such as water; ethanol; polyols (ex organic alcohols with 2 or more OH groups; ex propylene glycol/MPG; glycerol, sorbitol, inositol, dipropylene glycol; and so forth) and the overall ethanol amine content in the formulation (mono-, di-triethanolamine, including contributions from ex added “monoethanol amine surfactant” raw materials)

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well.

Variant: The term “variant” means a polypeptide having a specific enzyme activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position The variants of the present invention have at least 20%, e.g., at least 40%, at least 50%, at least 60%, at least 70%, at least 80%, at least 90%, at least 95%, or at least 100% of the specific enzyme activity of the mature polypeptide of the enzyme.

Wild-type [enzyme]: The term “wild-type” enzyme means a enzyme expressed by a naturally occurring microorganism, such as a bacterium, yeast, or filamentous fungus found in nature.

### Conventions for Designation of Variants

For purposes of the present invention, a specific polypeptide may be used to determine the corresponding amino acid residue in another enzyme. The amino acid sequence of another enzyme is aligned with the relevant SEQ ID NO, and based on the alignment, the amino acid position number corresponding to any amino acid residue in the polypeptide disclosed in the relevant SEQ ID NO is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix.

Identification of the corresponding amino acid residue in another enzyme can be determined by an alignment of multiple polypeptide sequences using several computer programs including, but not limited to, MUSCLE (multiple sequence comparison by log-expectation; version 3.5 or later; Edgar, 2004, Nucleic Acids Research 32: 1792-1797), MAFFT (version 6.857 or later; Katoh and Kuma, 2002, Nucleic Acids Research 30: 3059-3066; Katoh et al., 2005, Nucleic Acids Research 33: 511-518; Katoh and Toh, 2007, Bioinformatics 23: 372-374; Katoh et al., 2009, Methods in Molecular Biology 537: 39-64; Katoh and Toh, 2010, Bioinformatics 26: 1899-1900), and EMBOSS EMMA employing ClustalW (1.83 or later; Thompson et al., 1994, Nucleic Acids Research 22: 4673-4680), using their respective default parameters.

When the other enzyme has diverged from the mature polypeptide of the specific SEQ ID NO such that traditional sequence-based comparison fails to detect their relationship (Lindahl and Elofsson, 2000, J. Mol. Biol. 295: 613-615), other pairwise sequence comparison algorithms can be used. Greater sensitivity in sequence-based searching can be attained using search programs that utilize probabilistic representations of polypeptide families (profiles) to search databases. For example, the PSI-BLAST program generates profiles through an iterative database search process and is capable of detecting remote homologs (Atschul et al., 1997, Nucleic Acids Res. 25: 3389-3402). Even greater sensitivity can be achieved if the family or superfamily for the polypeptide has one or more representatives in the protein structure databases. Programs such as GenTHREADER (Jones, 1999, J. Mol. Biol. 287: 797-815; McGuffin and Jones, 2003, Bioinformatics 19: 874-881) utilize information from a variety of sources (PSI-BLAST, secondary structure prediction, structural alignment profiles, and solvation potentials) as input to a neural network that predicts the structural fold for a query sequence. Similarly, the method of Gough et al., 2000, J. Mol. Biol. 313: 903-919, can be used to align a sequence of unknown structure with the superfamily models present in the SCOP database. These alignments can in turn be used to generate homology models for the polypeptide, and such models can be assessed for accuracy using a variety of tools developed for that purpose.

For proteins of known structure, several tools and resources are available for retrieving and generating structural alignments. For example the SCOP superfamilies of proteins have been structurally aligned, and those alignments are accessible and downloadable. Two or more protein structures can be aligned using a variety of algorithms such as the distance alignment matrix (Holm and Sander, 1998, Proteins 33: 88-96) or combinatorial extension (Shindyalov and Bourne, 1998, Protein Engineering 11: 739-747), and implementation of these algorithms can additionally be utilized to query structure databases with a structure of interest in order to discover possible structural homologs (e.g., Holm and Park, 2000, Bioinformatics 16: 566-567).

In describing the variants of the present invention, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine (S) with phenylalanine (F), respectively.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions. For an amino acid insertion, the following nomenclature is used: Original amino acid, position, original amino acid, inserted amino acid. Accordingly the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases, the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

Multiple alterations. Variants comprising multiple alterations are separated by addition marks (“+”), e.g., “Arg170Tyr+Gly195Glu” or “R170Y+G195E” representing a substitution of arginine and glycine at positions 170 and 195 with tyrosine and glutamic acid, respectively.

Different alterations. Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants: “Tyr167Gly+Arg170Gly”, “Tyr167Gly+Arg170Ala”, “Tyr167Ala+Arg170Gly”, and “Tyr167Ala+Arg170Ala”.

### DETAILED DESCRIPTION OF THE INVENTION

The inventor has surprisingly found that the overall polarity of a liquid detergent must be in a certain range in order to increase the solubility of an enzyme in the liquid detergent to an acceptable level for obtaining significant performance of the detergent composition.

For enzymes which are not very soluble in liquid detergents it can be difficult to dissolve an amount of enzyme sufficient for the specific enzyme to work during the washing process. By increasing the solubility of enzymes in liquid detergents it is ensured that a larger amount of enzyme can be dissolved in the liquid detergent maintaining the physical appearance of the detergent and this leads to increased stain removal compared to liquid detergents which do not have a sufficient solubility of the enzyme. This effect can be demonstrated by measuring ΔRem.

The overall polarity of a detergent composition of the present invention can be described by having a Hansen Solubility Parameter (δ) comparable (+/−10, preferably +/−7, preferably +/−5, more preferably +/−4, most preferably +/−3) to that of the specific enzyme in question.

Alternatively the overall polarity of a detergent composition of the present invention can be described by having a Hansen Solubility Parameter hydrogen bonding component (δh) comparable (+/−7, preferably +/−5, more preferably +/−4, more preferably +/−3, most preferably +/−2) to that of the specific enzyme in question.

The present invention concerns a method for increasing the solubility of an enzyme in a liquid detergent composition comprising one or more enzymes, an anionic surfactant and a solvent system, which liquid detergent composition has a Hansen Solubility Parameter hydrogen bonding contribution (δh) in the range of 2-35.

The visual appearance of the liquid detergent is important to the consumer. The liquid product appeals to the consumer if it is a clear solution without precipitate. The inventive method ensures that the sufficient amount of enzyme is dissolved in the liquid detergent and that no precipitate forms during the storage of the product. Moreover, precipitated enzyme or partly precipitated enzyme in a liquid detergent may be unstable and thereby nonactive when the liquid detergent is used in a washing process. The method of the present invention ensures that the sufficient amount of enzyme is dissolved and kept in solution during storage. The stain removal capacity and the washing effect of the liquid detergent is thereby improved. This effect can be demonstrated by measuring ΔRem.

Another advantage of increasing the solubility of an enzyme in a liquid detergent can be found during the production, where the dissolved enzyme ensures that equal amounts of enzymes is tapped into each pouch or capsule without constantly stirring of the solution.

In one embodiment, the invention concerns a liquid detergent composition comprising one or more enzymes, an anionic surfactant and a solvent system, which liquid detergent composition has a Hansen Solubility Parameter hydrogen bonding contribution (δh) in the range of 2-35.

The inventor has found that the overall Hansen solubility parameter H-bonding (hydrogen bonding) contribution (δh) of the detergent, the overall Hansen solubility parameter H-bonding contribution (δh) of the solvent system, and the overall Hansen solubility parameter (δ) for the solvent system is important for the solubility of enzymes present in the liquid detergent composition.

It was found that the δp and δd parameters only had minor influence.

In one embodiment of the invention, the Hansen Solubility Parameter hydrogen bonding contribution (δh) of the liquid detergent composition is in the range of 2-35, in the range of 3-30, in the range of 4-29, in the range of 4-28, in the range of 5-26, in the range of 5-25, in the range of 6-25, in the range of 6-25 in the range of 6-20 or in the range 8-18; 10-18; or in the range of 12-18.

In one embodiment of the invention, the solvent system of the liquid detergent composition has a Hansen Solubility parameter hydrogen bonding parameter contribution (δh) in the range of 4-30. In one embodiment, the solvent system has a Hansen Solubility parameter hydrogen bonding parameter contribution (δh) in the range of 4-25, in the range of 4-20, in the range of 5-16, in the range of 6-15, or in the range of 8-15.

In one embodiment, the solvent system has a Hansen Solubility parameter (δ) in the range of 3-20. In one embodiment the Hansen Solubility parameter (δ) in the range of 5-18, 6-15, 9-15, or in the range of 10-17.

The overall polarity of solvent system in a detergent composition of the present invention for achieving adecuate enzymes solubility can be described by having a Hansen Solubility Parameter (δ) contribution of at least 3, at least 4, at least 6, at least 7, at least 8, at least 9 or at least 10.

In one embodiment, the overall polarity of solvent system in a detergent composition of the present invention for achieving adecuate enzymes solubility can be described by having a Hansen Solubility Parameter hydrogen bonding contribution (δh) contribution of at least 4, at least 5; at least 6, at least 7, at least 8, at least 8, at least 10 or at least 11.

In one embodiment, the overall polarity the complete system in a detergent composition of the present invention for achieving adecuate enzymes solubility can be described by having a Hansen Solubility Parameter hydrogen bonding contribution (δh) contribution of at least 5, at least 7, at least 9, at least 11, at least 13, at least 14, at least 15, at least 16, at least 17, at least 18, at least 19 or at least 20.

The overall polarity of solvent system in a detergent composition of the present invention for achieving adecuate enzymes solubility can be described by having a Hansen Solubility Parameter (δ) contribution of maximum 30, maximum 25, maximum 20, maximum 18; maximum 17; maximum 16, maximum 15 or maximum 14.

In one embodiment, the overall polarity of solvent system in a detergent composition of the present invention for achieving adecuate enzymes solubility can be described by having a Hansen Solubility Parameter hydrogen bonding contribution (δh) contribution of at maximum 30, maximum 25, maximum 22, maximum 20 or maximum 18.

In one embodiment, the overall polarity the complete system in a detergent composition of the present invention for achieving adecuate enzymes solubility can be described by having a Hansen Solubility Parameter hydrogen bonding contribution (δh) contribution of maximum 35, maximum 30, maximum 29, maximum 28, maximum 27, maximum 26 or maximum 25.

In one embodiment of the invention, the solvent system comprises solvents selected from the group consisting of water, alcohols, polyols, sugars and/or mixtures thereof.

In one embodiment, the polyol is selected from the group consisting of glycerol, sorbitol, propylene glycol (MPG), 1,2-propanediol, 1,3-propane diol, dipropylene glycol (DPG), polyethylene glycol family (PEG300-600), hexylene glycol, inositol and mannitol.

In one embodiment, the alcohol is selected from the group consisting of ethanol, isopropanol, n-butoxy propoxy propanol and ethanolamines such as monoethanol amine diethanol amines and triethanol amines.

In one embodiment, the sugar is selected from the group consisting of sucrose, dextrose, glucose, ribose, xylose and related mono and di pyranosides and furanosides.

In one embodiment, liquid detergent composition comprises in the range of 5-60% of a solvent system. In one embodiment liquid detergent composition comprises in the range of 5-40% or 10-30% of a solvent system.

The liquid detergent system also comprises an anionic surfactant. The anionic surfactant may be selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid fatty acids and/or salt of fatty acids and mixtures thereof.

The liquid detergent may comprise one anionic surfactant or it may comprise a mixture of more than one anionic surfactant, such as two anionic surfactants, three anionic surfactants, four anionic surfactants, five anionic surfactants, six anionic surfactants, seven anionic surfactants or event eight anionic surfactants.

The total amount of the anionic surfactant in the liquid detergent is in the range of 0.1-60% of anionic surfactant. In one embodiment of the invention, the total amount of anionic surfactant is in the range of 5-50%, in the range of 5-30%, in the range of 5-15%, in the range of 15-20% or in the range of 20-25%.

The invention relates to liquid detergent composition comprising a minor amount of water. In one embodiment of the invention the water content of the liquid detergent is below 15%, such as below 12%. In one embodiment of the invention the water content is below 11%, below 10%, below 9%, below 8%, below 7%, below 6%, below 5%, below 4%, below 3%, below 2% or below 1%. In one embodiment the liquid detergent composition does not comprise water.

In one embodiment of the invention, the enzyme having increased solubility in a liquid detergent is selected from the group consisting of protease, lipase, cutinase, amylase, carbohydrase, cellulase, pectate lyase, pectinase, mannanase, arabinase, galactanase, and/or xylanase.

In one embodiment, the enzyme having increased solubility is a lipase of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase™, Lipex™, Lipolex™ and Lipoclean™ (Novozymes NS), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

The inventor has found that the overall Hansen solubility parameter hydrogen bonding contribution (δh) and the Hansen solubility parameter (δ) and the Hansen solubility parameter hydrogen bonding contribution (δh) of the solvent system are important for the solubility of lipase present in the liquid detergent composition.

The overall polarity of solvent system in a detergent composition of the present invention for achieving adecuate lipase solubility can be described by having a Hansen Solubility Parameter (δ) contribution of at least 6, at least 7, at least 8 or at least 10.

In one embodiment, the overall polarity of solvent system in a detergent composition of the present invention for achieving adecuate lipase solubility can be described by having a Hansen Solubility Parameter hydrogen bonding contribution (δh) contribution of at least 8, at least 9, at least 10, at least 11, at least 12 or at least 13.

In one embodiment, the overall polarity the complete system in a detergent composition of the present invention for achieving adecuate lipase solubility can be described by having a Hansen Solubility Parameter hydrogen bonding contribution (δh) contribution of at least 12, at least 13, at least 14, at least 15, at least 16, at least 17, at least 18, at least 19 or at least 20.

The overall polarity of solvent system in a detergent composition of the present invention for achieving adecuate lipase solubility can be described by having a Hansen Solubility Parameter (δ) contribution of maximum 30, maximum 25, maximum 20, maximum 18; maximum 17; maximum 16 or maximum 15.

In one embodiment, the overall polarity of solvent system in a detergent composition of the present invention for achieving adecuate lipase solubility can be described by having a Hansen Solubility Parameter hydrogen bonding contribution (δh) contribution of at maximum 30, maximum 25, maximum 22, maximum 20 or maximum 18.

In one embodiment, the overall polarity the complete system in a detergent composition of the present invention for achieving adecuate lipase solubility can be described by having a Hansen Solubility Parameter hydrogen bonding contribution (δh) contribution of maximum 35, maximum 30, maximum 29, maximum 28, maximum 27, maximum 26 or maximum 25.

In one embodiment of the invention, the enzyme having increased solubility is a polypeptide having at least 90%, such as at least 95%, sequence identity to amino acids number 1 to 269 or SEQ ID NO: 2 or a variant thereof wherein the polypeptide comprises the following substitutions T231R and N233R; In one embodiment of the invention, the enzyme having increased solubility is selected from the group of isolated lipase variants, comprising a substitution at one or more (e.g., several) positions corresponding to positions T37A,D,E,F,G,H,I,L,N,P,Q,R,S,V,W,Y, N39A,C,D,E,F,G,I,K,L,M,P,Q,R,T,V,W,Y, and G91D,H,I,P,Q of the mature polypeptide of SEQ ID NO: 2, wherein the variant has lipase activity.

In an embodiment, the variant has sequence identity of at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, or at least 99%, but less than 100%, to the amino acid sequence of the parent lipase.

In another embodiment, the variant has at least 60%, e.g., at least 65%, at least 70%, at least 75%, at least 80%, at least 85%, at least 90%, at least 91%, at least 92%, at least 93%, at least 94%, at least 95%, such as at least 96%, at least 97%, at least 98%, or at least 99%, but less than 100%, sequence identity to the mature polypeptide of SEQ ID NO: 2.

In one embodiment, the number of substitutions in the variants of the present invention is 1-20, e.g., 1-10 and 1-5, such as 1, 2, 3, 4, 5, 6, 7, 8, 9, 10, 11, 12, 13, 14, 15, 16, 17, 18, 19, or 20 substitutions.

In another embodiment, a variant comprises an substitution at one or more (e.g., several) positions corresponding to positions T37A,D,E,F,G,H,I,L,N,P,Q,R,S,V,W,Y, N39A,C,D,E,F,G,I,K,L,M,P,Q,R,T,V,W,Y, and G91D,H,I,P,Q of the mature polypeptide of SEQ ID NO: 2. In another embodiment, a variant comprises an alteration at two positions corresponding to any of positions T37A,D,E,F,G,H,I,L,N,P,Q,R,S,V,W,Y, N39A,C,D,E,F,G,I,K,L,M,P,Q,R,T,V,W,Y, and G91D,H,I,P,Q of the mature polypeptide of SEQ ID NO: 2.

In another embodiment, a variant comprises an alteration at three positions corresponding to any of positions T37A,D,E,F,G,H,I,L,N,P,Q,R,S,V,W,Y, N39A,C,D,E,F,G,I,K,L,M,P,Q,R,T,V,W,Y, and G91D,H,I,P,Q of the mature polypeptide of SEQ ID NO: 2.

In another embodiment, the variant comprises or consists of a substitution at a position corresponding to position T37 of the mature polypeptide of SEQ ID NO: 2 which is substituted with Ala, Arg, Asn, Asp, Cys, Gln, Glu, Gly, His, Ile, Leu, Lys, Met, Phe, Pro, Ser, Thr, Trp, Tyr, or Val, preferably with Ala, Arg, Asn, Asp, Gln, Glu, Gly, His, Ile, Leu, Phe, Pro, Ser, Trp, Tyr, or Val.

In another embodiment, the variant comprises or consists of the substitution T37A, T37D, T37E, T37F, T37G, T37H, T371, T37L, T37N, T37P, T37Q, T37R, T37S, T37V, T37W, or T37Y of the mature polypeptide of SEQ ID NO: 2.

In another embodiment, the variant comprises or consists of a substitution at a position corresponding to position N39 of the mature polypeptide of SEQ ID NO: 2 which is substituted with Ala, Arg, Asn, Asp, Cys, Gin, Glu, Gly, His, Ile, Leu, Lys, Met, Phe, Pro, Ser, Thr, Trp, Tyr, or Val, preferably with Ala, Arg, Asp, Cys, Gin, Glu, Gly, Ile, Leu, Lys, Met, Phe, Pro, Thr, Trp, Tyr, or Val.

In another aspect, the variant comprises or consists of the substitution N39A, N39C, N39D, N39E, N39F, N39G, N39I, N39K, N39L, N39M, N39P, N39Q, N39R, N39T, N39V, N39W, N39Y of the mature polypeptide of SEQ ID NO: 2.

In another embodiment, the variant comprises or consists of a substitution at a position corresponding to position G91 of the mature polypeptide of SEQ ID NO: 2 which is substituted with Ala, Arg, Asn, Asp, Cys, Gln, Glu, Gly, His, Ile, Leu, Lys, Met, Phe, Pro, Ser, Thr, Trp, Tyr, or Val, preferably with Asp, Gln, His, Ile, or Pro. In another embodiment, the variant comprises or consists of the substitution G91D, G91H, G91I, G91P, G91Q or even G91A of the mature polypeptide of SEQ ID NO: 2. In a preferred embodiment the variant comprises or consists of a substitution at a position corresponding to G91 which is G91A.

In another embodiment, any such one or more substitutions at position 37, 39 and/or 91 is combined with one or more, preferably both of T231R and N233R.

In another embodiment, the variant comprises or consists of substitutions at positions corresponding to positions T37 and N39, such as those described above.

In another embodiment, the variant comprises or consists of substitutions at positions corresponding to positions T37 and G91, such as those described above.

In another embodiment, the variant comprises or consists of substitutions at positions corresponding to positions N39 and G91, such as those described above.

In another embodiment, the variant comprises or consists of substitutions at positions corresponding to positions T37, N39, and G91, such as those described above.

The variants may further comprise one or more additional substitutions at one or more (e.g., several) other positions.

The amino acid changes may be of a minor nature, that is conservative amino acid substitutions or insertions that do not significantly affect the folding and/or activity of the protein, small deletions, typically of 1-30 amino acids, small amino or carboxyl-terminal extensions, such as an amino-terminal methionine residue, a small linker peptide of up to 20-25 residues, or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine).

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

For example, the variants may comprise a substitution at a position corresponding to positions D96, T143, A150, E210, G225, T231, N233 and P250 of the mature polypeptide of SEQ ID NO: 2. In some embodiments the substitution is selected from D96G, T143A, A150G, E210Q, G225R, T231R, N233R and P250R.

In some embodiments, the invention relates to variants selected from:

### G91Q+T143A+E210Q+T231R+N233R+P250R

### G91Q+A150G+E210Q+T231R+N233R+P250R

### T37R+N39R+G91A+D96G+T231R+N233R

### G91Q+E210Q+T231R+N233R+P250R

### G91I+E210Q+T231R+N233R+P250R

### G91A+D96G+T231R+N233R

### G91A+D96G+G225R+T231R+N233R

### G91N+E210Q+T231R+N233R+P250R

### G91L+E210Q+T231R+N233R

### G91A+D96G+A150G+T231R+N233R

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for lipase activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide.

The variants may consist of at least 50%, at least 55%, at least 60%, at least 65%, at least 70%, at least 75%, at least 80%, at least 85%, at least 90%, and at least 95% of the number of amino acids of the mature polypeptide.

The lipase variants described above can be produced as described in European patent application No. 12153817.7.

In one embodiment of the invention, the enzyme having increased solubility is an alpha-amylase or a glucoamylase of bacterial or fungal origin. The alpha-amylase or the glucoamylase can be chemically modified or protein engineered.

In one embodiment of the invention, the amylase is selected from the group consisting of
a. amylases having SEQ ID NO: 3 or variants having 90% sequence identity to SEQ ID NO: 3 thereof,
b. amylase variants of SEQ ID NO: 3 with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444,
c. amylases having SEQ ID NO: 4 or variants thereof having 90% sequence identity to SEQ ID NO: 4, preferred variants of SEQ ID NO: 4 are those having a deletion in positions 181 and 182 and a substitution in position 193,
d. an amylase having at least 90%, such as at least 95%, sequence identity to the hybrid polypeptide of SEQ ID NO: 5: 5,
   or variants having 90% sequence identity thereof, preferred variants are those having a substitution, a deletion or an insertion in one of more of the following positions: G48, T49, G107, H156, A181, N190, M197, I201, A209, Q264, M197T; H156Y+A181T+N190F+A209V+Q264S G48A+T49I+G107A+H156Y+A181T+N190F+I201F+A209V+Q264S;
e. amylases having SEQ ID NO: 6 or variants thereof having 90% sequence identity to SEQ ID NO: 6, preferred variants of SEQ ID NO: 6 are those having a substitution, a deletion or an insertion in one or more of the following positions: R181, G182, H183, G184, N195, 1206, E212, E216 and K269. particularly preferred amylases are those having deletion in positions R181 and G182, or positions H183 and G184,
f. amylases having SEQ ID NO: 7, SEQ ID NO: 8 or SEQ ID NO: 9 or variants thereof having 90% sequence identity to SEQ ID NO: 7, SEQ ID NO: 8 or SEQ ID NO: 9; preferred variants of SEQ ID NO: 7, SEQ ID NO: 8 or SEQ ID NO: 9 are those having a substitution, a deletion or an insertion in one or more of the following positions: 140, 181, 182, 183, 184, 195, 206, 212, 243, 260, 269, 304 and 476; more preferred variants are those having a deletion in positions 181 and 182 or positions 183 and 184, most preferred amylase variants of SEQ ID NO: 7, SEQ ID NO: 8 or SEQ ID NO: 9 are those having a deletion in positions 183 and 184 and a substitution in one or more of positions 140, 195, 206, 243, 260, 304 and 476,
g. amylases having SEQ ID NO: 10, or variants thereof having 90% sequence identity to SEQ ID NO: 10,
h. amylases having SEQ ID NO: 11, or variants thereof having 90% sequence identity to SEQ ID NO: 11,
i. amylases having SEQ ID NO: 12 or variants having 90% sequence identity to SEQ ID NO: 12 thereof, preferred variants of SEQ ID NO: 12 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475, more preferred variants of SEQ ID NO: 12 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183, even more preferred amylase variants of SEQ ID NO: 12 are those having the substitutions:
   N128C+K178L+T182G+Y305R+G475K;
   N128C+K178L+T182G+F202Y+Y305R+D319T+G475K;
   S125A+N128C+K178L+T182G+Y305R+G475K; or
   S125A+N128C+T131I+T165I+K178L+T182G+Y305R+G475K, wherein the variants are C-terminally truncated and optionally further comprises a substitution at position 243 and/or a deletion at position 180 and/or position 181,
j. alpha-amylase having SEQ ID NO: 13 or a variant having at least 90% sequence identity to SEQ ID NO: 13, preferred amylase variants are those having a substitution, a deletion or an insertion in one of more of the following positions of SEQ ID NO: 13: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484, particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions, and
k. amylase having SEQ ID NO: 14 or a variant having at least 90% sequence identity to SEQ ID NO: 14.

The inventor has found that the overall Hansen solubility parameter hydrogen bonding contribution (δh) and the Hansen solubility parameter (δ) and the Hansen solubility parameter hydrogen bonding contribution (δh) of the solvent system are important for the solubility of amylase present in the liquid detergent composition.

The overall polarity of solvent system in a detergent composition of the present invention for achieving adecuate enzymes solubility can be described by having a Hansen Solubility Parameter (δ) contribution of at least 2, at least 3, at least 4, at least 5; at least 6, at least 7, at least 8 or at least 9.

In one embodiment, the overall polarity of solvent system in a detergent composition of the present invention for achieving adecuate amylase solubility can be described by having a Hansen Solubility Parameter hydrogen bonding contribution (δh) contribution of at least 4, at least 5; at least 6, at least 7, at least 8, at least 8, at least 10 or at least 11 or at least 12.

In one embodiment, the overall polarity the complete system in a detergent composition of the present invention for achieving adecuate amylase solubility can be described by having a Hansen Solubility Parameter hydrogen bonding contribution (δh) contribution of at least 5, at least 7, at least 9, at least 11, at least 13, at least 14, at least 15, at least 16, at least 17, at least 18, at least 19 or at least 20.

The overall polarity of solvent system in a detergent composition of the present invention for achieving adecuate amylase solubility can be described by having a Hansen Solubility Parameter (δ) contribution of maximum 30, maximum 25, maximum 20, maximum 18; maximum 17; maximum 16, maximum 15 or maximum 14.

In one embodiment, the overall polarity of solvent system in a detergent composition of the present invention for achieving adecuate amylase solubility can be described by having a Hansen Solubility Parameter hydrogen bonding contribution (δh) contribution of at maximum 30, maximum 25, maximum 22, maximum 20 or maximum 18.

In one embodiment, the overall polarity the complete system in a detergent composition of the present invention for achieving adecuate amylase solubility can be described by having a Hansen Solubility Parameter hydrogen bonding contribution (δh) contribution of maximum 35, maximum 30, maximum 29, maximum 28, maximum 27, maximum 26 or maximum 25.

In one embodiment of the invention, the enzyme having increased solubility is a protease. 1.

In one embodiment the enzyme is a protease having at least 90%, such as at least 95% or 99% sequence identity to SEQ ID NO: 15. Proteases include those of animal, vegetable or microbial origin. Microbial origin is preferred. Chemically modified or protein engineered mutants are included. The protease may be a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Preferred commercially available protease enzymes include Alcalase™, Savinase™ Liquanase, Ovozyme, Blaze, Neutrase, Coronase, Primase™, Duralase™, Esperase™, and Kannase™ (Novozymes NS), Maxatase™, Maxacal™, Maxapem™, Properase™, Purafect™ Purafect OxP™, FN2™, and FN3™ (Genencor International Inc.).

The inventor has found that the overall Hansen solubility parameter hydrogen bonding contribution (δh) and the Hansen solubility parameter (δ) and the Hansen solubility parameter hydrogen bonding contribution (δh) of the solvent system are important for the solubility of protease present in the liquid detergent composition.

The overall polarity of solvent system in a detergent composition of the present invention for achieving adecuate protease solubility can be described by having a Hansen Solubility Parameter (δ) contribution of at least 2, at least 3, at least 4, at least 5; at least 6; at least 7; at least 8 or at least 9.

In one embodiment, the overall polarity of solvent system in a detergent composition of the present invention for achieving adecuate protease solubility can be described by having a Hansen Solubility Parameter hydrogen bonding contribution (δh) contribution of at least 4, at least 5; at least 6, at least 7, at least 8, at least 8, at least 10 or at least 11

In one embodiment, the overall polarity the complete system in a detergent composition of the present invention for achieving adecuate protease solubility can be described by having a Hansen Solubility Parameter hydrogen bonding contribution (δh) contribution of at least 5, at least 7, at least 9, at least 11, at least 13, at least 14, at least 15, at least 16, at least 17, at least 18, at least 19 or at least 20.

The overall polarity of solvent system in a detergent composition of the present invention for achieving adecuate protease solubility can be described by having a Hansen Solubility Parameter (δ) contribution of maximum 30, maximum 25, maximum 20, maximum 18; maximum 17; maximum 16, maximum 15 or maximum 14.

In one embodiment, the overall polarity of solvent system in a detergent composition of the present invention for achieving adecuate protease solubility can be described by having a Hansen Solubility Parameter hydrogen bonding contribution (δh) contribution of at maximum 30, maximum 25, maximum 22, maximum 20 or maximum 18.

In one embodiment, the overall polarity the complete system in a detergent composition of the present invention for achieving adecuate protease solubility can be described by having a Hansen Solubility Parameter hydrogen bonding contribution (δh) contribution of maximum 35, maximum 30, maximum 29, maximum 28, maximum 27, maximum 26 or maximum 25.

In one embodiment of the invention, the liquid detergent composition comprises 0.001-5 mg enzyme per gram detergent of the enzyme exhibiting increased solubility. In one embodiment the enzyme exhibiting increased solubility is in the range of 0.005-1 mg enzyme per gram detergent composition, in the range of 0.008-0.6 mg enzyme per gram detergent composition, in the range of 0.01-0.5 mg enzyme per gram detergent composition or in the range of 0.02-0.3 mg enzyme per gram detergent composition.

In one embodiment of the invention, the liquid detergent comprising the enzyme having increased solubility also comprises at least one additional enzyme. The additional enzyme is selected from the group consisting of protease, lipase, cutinase, amylase, carbohydrase, cellulase, pectate lyase, pectinase, mannanase, arabinase, galactanase, and/or xylanase.

In one embodiment, the invention is directed to liquid detergent compositions comprising an enzyme having increased solubility in combination with one or more additional cleaning composition components. The choice of additional components is within the skill of the artisan and includes conventional ingredients, including the exemplary non-limiting components set forth below.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 5% to 60% by weight, such as about 5% to about 50%, or about 10% to about 50%, or about 20% to about 50%. The surfactant(s) is chosen based on the desired cleaning application, and may include any conventional surfactant(s) known in the art.

When included therein the detergent will usually contain from about 5% to about 60% by weight of one or more anionic surfactants, such as from about 5% to about 40%, including from about 10% to about 25%, Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salts of fatty acids (soap) or fatty acids, and combinations thereof.

When included therein the detergent will usually contain from about from about 0.1% to about 10% by weigh of a cationic surfactant, for example from about 0.1% to about 5%, Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 60% by weight of a nonionic surfactant, for example from about 1% to about 40%, in particular from about 5% to about 20%, from about 3% to about 15%, Non-limiting examples of nonionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), methylester ethoxylates (MEE), as well as products available under the trade names SPAN and TWEEN, and combinations thereof.

When included therein the detergent will usually contain from about 0.1% to about 10% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, and combinations thereof.

When included therein the detergent will usually contain from about 0.1% to about 10% by weight of a zwitterionic surfactant. Non-limiting examples of zwitterionic surfactants include betaines such as alkyldimethylbetaines, sulfobetaines, and combinations thereof.

Solvent system: For dissolution of the surfactant and other detergent ingredients, a solvent system is neede. Solvents are typically water, alcohols, polyols, sugars and/or mixtures thereof. Preferred solvents are water, glycerol, sorbitol, propylene glycol (MPG, 1,2-propanediol or 1,3-propane diol), dipropylene glycol (DPG), polyethylene glycol family (PEG300-600), hexylene glycol, inositol, mannitol, Ethanol, isopropanol, n-butoxy propoxy propanol, ethanolamines (monoethanol amine, diethanol amines and triethanol amines), sucrose, dextrose, glucose, ribose, xylose, and related mono and di pyranosides and furanosides.

The solvent system is present in typically totally 5-90%, 5-60%, 5-40%, 10-30% by weight.

The water content for unit doses wrapped in PVA film is typically in the range 1-15%, 2-12%, 3-10%, 5-10%.

The polyol content for unit doses wrapped in PVA film is typically in the range 5-50%, 10-40% or 20-30%.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants), however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65%, 0-20%;% or 0.5-5% of a detergent builder or co-builder, or a mixture thereof. In a dish wash detergent, the level of builder is typically 10-65%, particularly 20-40%. The builder and/or co-builder may particularly be a chelating agent that forms water-soluble complexes with Ca and Mg. Any builder and/or co-builder known in the art for use in laundry detergents may be utilized. Nonlimiting examples are citrate, sodium carbonate, sodium bicarbonate and sodium citrate, Examples of phosphonates include 1-Hydroxy Ethylidene-1,1-Diphosphonic Acid (HEDP, etidronic acid), Diethylenetriamine Penta(Methylene Phosphonic acid) (DTPMP), Ethylene diamine tetra(methylene phosphonic acid) (EDTMPA), amino tris(methylenephosphonic acid) (ATMP), Nitrilo trimethylene phosphonic acid (NTMP), 2-Amino ethyl phosphonic acid (AEPn), Dimethyl methylphosphonate (DMPP),Tetramethylene diamine tetra(methylene phosphonic acid) (TDTMP), Hexamethylene diamine tetra(methylene phosphonic acid) (HDTMP), Phosphonobutane-tricarboxylic acid (PBTC), N-(phosphonomethyl)iminodiacetic acid (PMIDA), 2-carboxyethyl phosphonic acid (CEPA), 2-Hydroxy phosphonocarboxylic acid (HPAA) and Amino-tris-(methylene-phosphonic acid) (AMP). L-glutamic acid N,N-diacetic acid tetra sodium salt (GLDA), methylglycinediacetic acid (MGDA). Non-limiting examples of builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

The detergent may contain 0-30% by weight, such as about 1% to about 20%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate, sodium perborates and hydrogen peroxide-urea (1:1), preformed peracids and mixtures thereof. Suitable preformed peracids include, but are not limited to, peroxycarboxylic acids and salts, diperoxydicarboxylic acids, acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with hydrogen peroxide to form a peracid via perhydrolysis. The peracid thus formed constitutes the activated bleach. Suitable bleach activators to be used herein include those belonging to the class of esters, amides, imides or anhydrides. Suitable examples are tetraacetylethylenediamine (TAED), sodium 4-[(3,5,5-trimethylhexanoyl)oxy]benzene-1-sulfonate (ISONOBS), 4-(dodecanoyloxy)benzene-1-sulfonate (LOBS), 4-(decanoyloxy)benzene-1-sulfonate, 4-(decanoyloxy)benzoate (DOBS or DOBA), 4-(nonanoyloxy)benzene-1-sulfonate (NOBS), and/or those disclosed in WO98/17767. A particular family of bleach activators of interest was disclosed in EP624154 and particulary preferred in that family is acetyl triethyl citrate (ATC). ATC or a short chain triglyceride like triacetin has the advantage that it is environmentally friendly Furthermore acetyl triethyl citrate and triacetin have good hydrolytical stability in the product upon storage and are efficient bleach activators. Finally ATC is multifunctional, as the citrate released in the perhydrolysis reaction may function as a builder. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group consisting of organic catalysts having the following formulae:

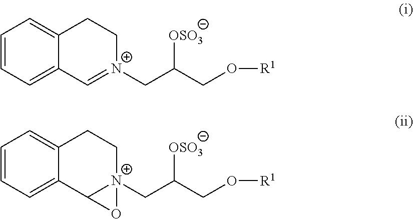

(iii) and mixtures thereof,

wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl. Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO); PEG-136 polyvinyl acetate and diquaternium ethoxy sulfate. Other exemplary polymers are disclosed in, e.g., WO 2006/130575. Salts of the above-mentioned polymers are also contemplated.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Enzymes

The detergent additive as well as the detergent composition may comprise one or more additional enzymes such as a protease, lipase, cutinase, an amylase, carbohydrase, cellulase, pectinase, mannanase, arabinase, galactanase, pectate lyase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts. The adecuate amounts of enzymes is determined by the desired detergency and is typically in the range of 1-5000 ppm (active enzyme) in detergent

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include Celluzyme™, and Carezyme™, Celluclean, Whitezyme (Novozymes A/S), Clazinase™, and Puradax HA™ (Genencor International Inc.), and KAC-500(B)™ (Kao Corporation).

Proteases: Suitable proteases include those of animal, vegetable or microbial origin. Microbial origin is preferred. Chemically modified or protein engineered mutants are included. The protease may be a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Preferred commercially available protease enzymes include Alcalase™, Savinase™ Liquanase, Ovozyme, Blaze, Neutrase, Coronase, Primase™, Duralase™, Esperase™, and Kannase™ (Novozymes NS), Maxatase™, Maxacal™, Maxapem™, Properase™, Purafect™ Purafect OxP™, FN2™, and FN3™ (Genencor International Inc.).

Lipases and Cutinases: Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include Lipolase™, Lipex™, Lipolex™ and Lipoclean™ (Novozymes NS), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

Amylases:

Suitable amylases which can be used in the detergent of the invention may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 3 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48A+T49I+G107A+H156Y+A181T+N190F+I201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476. More preferred variants are those having a deletion in positions 181 and 182 or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T165I+K178L+T182G+Y305R+G475K wherein the variants are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X, Everest, Termamyl Ultra and BAN™ (from Novozymes NS), and Rapidase™, Purastar™, and Powerase (from Genencor International Inc.).

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes NS).

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000, ethoxylated nonylphenols having from 16 to 50 ethylene oxide units, ethoxylated fatty alcohols in which the alcohol contains from 12 to 20 carbon atoms and in which there are 15 to 80 ethylene oxide units, fatty alcohols, fatty acids, and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

Lyases: The lyase may be a pectate lyase derived from Bacillus, particularly B. licherniformis or B. agaradhaerens, or a variant derived of any of these, e.g. as described in U.S. Pat. No. 6,124,127, WO 99/027083, WO 99/027084, WO 02/006442, WO 02/092741, WO 03/095638, A commercially available pectate lyase is XPect, Pectawash and Pectaway (Novozymes NS).

Mannanase: The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 99/064619. A commercially available mannanase is Mannaway (Novozymes NS).

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, Calcium, Sodium or Calcium formate, peptide aldehydes and hydrosulfite adducts thereof, CMC, and/or polyols such as propylene glycol), fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

Dye Transfer Inhibiting Agents—The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.
Fluorescent whitening agent—The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino)stilbene-2,2′-disulfonate, 4,4′-bis-(2,4-dianilino-s-triazin-6-ylamino)stilbene-2.2′-disulfonate, 4,4′-bis-(2-anilino-4-(N-methyl-N-2-hydroxy-ethylamino)-s-triazin-6-ylamino)stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino)stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

Soil release polymers—The detergent compositions of the present invention may also include one or more soil release polymers which aid the removal of soils from fabrics such as cotton and polyester based fabrics, in particular the removal of hydrophobic soils from polyester based fabrics.

The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

Anti-redeposition agents—The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.
Other suitable adjunct materials include, but are not limited to, anti-shrink agents, anti-wrinkling agents, bactericides, binders, carriers, dyes, enzyme stabilizers, protease inhibitors, fabric softeners, fillers, foam regulators, hydrotropes, perfumes, pigments, sod suppressors, solvents, and structurants for liquid detergents and/or structure elasticizing agents.

Rheology Modifiers—are structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

In a preferred embodiment of the present invention, the composition comprises a rheology modifier. The rheology modifier is selected from the group consisting of non-polymeric crystalline, hydroxy-functional materials, polymeric rheology modifiers which impart shear thinning characteristics to the aqueous liquid matrix of the composition. Crystalline, hydroxy-functional materials are rheology modifiers which form thread-like structuring systems throughout the matrix of the composition upon in situ crystallization in the matrix. Specific examples of preferred crystalline, hydroxyl-containing rheology modifiers include castor oil and its derivatives. Especially preferred are hydrogenated castor oil derivatives such as hydrogenated castor oil and hydrogenated castor wax. Commercially available, castor oil-based, crystalline, hydroxyl-containing rheology modifiers include THIXCIN® from Rheox, Inc. (now Elementis). Polymeric rheology modifiers are preferably selected from polyacrylates, polymeric gums, other non-gum polysaccharides, and combinations of these polymeric materials. Preferred polymeric gum materials include pectine, alginate, arabinogalactan (gum Arabic), carrageenan, gellan gum, xanthan gum, guar gum and mixtures thereof.

### Formulation of Detergent Products

The detergent composition of the invention may be in any convenient form, e.g., a pouch having one or more compartments, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids. Ref: (US2009/0011970 A1).

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

The invention also relates to detergent packs and multi-component products suitable for use in an automatic dishwashing machine or dishwashing pretreatment to provide baked and burnt-on soil removal and other cleaning benefits. In one embodiment, there is provided an automatic dishwashing detergent pack comprising two or more automatic dishwashing detergent and/or auxiliary products, storage means comprising separate but associated portions of the two or more products and means, for example electric pump means, for delivering quantities of the two or more products into the same or different cycles of an automatic dishwashing machine. The pack can also comprise means for controlling the relative dispensing rate of the two or more products from the storage means. The pack preferably comprises an organic solvent composition and an automatic dishwashing detergent composition and is used for removing cooked-, baked-, and burnton food soil from cookware and tableware. In a preferred embodiment the two or more automatic dishwashing detergent or auxiliary products are in rheology-matched gel-form.

Compositions are considered to be rheology-matched if they have similar yield values (differing by less than about 50%, preferably by less than about 20%) and/or similar viscosities (differing by less than about 50%, preferably by less than about 20%) under the same shear conditions.

The invention also relates to organic solvent compositions suitable for use in automatic dishwashing or dishwashing pretreatment. In one embodiment, an organic solvent composition comprises about 1% to about 99%, preferably from about 5% to about 90% of an organic solvent system for removing cooked-, baked-, or burnt-on food soil from cookware and tableware, from about 0.5% to about 50%, preferably from about 5% to about 25% of bleach and from about 0.0001% to about 10% of detergency enzyme. The compositions preferably are in gel-form and contain a thickener such as methylcellulose or other nonionic cellulosic thickener. The solvent compositions are preferably anhydrous (containing less than about 5%, preferably less than about 1% of water) and comprise bleach in the form of a particulate suspension having an average particle size in the range from about 10 to about 100, um, preferably from about 25 to about 75 um. The compositions are also builder free or generally builder free. It is a feature of the invention that a broad range of solvents, including organoamine solvents can be incorporated in the solvent compositions of the invention with acceptable bleach stability provided the water content of the composition is carefully controlled.

The invention also relates to detergent compositions suitable for use in automatic dishwashing or dishwashing pretreatment. In one embodiment, an automatic dishwashing detergent composition comprises from about 0.05% to about 10% by weight of a low foaming non-ionic surfactant, from about 1% to about 30% of an organoamine, preferably alkanolamine (especially monoethanolamine) solvent and at least about 5% by weight of a detergency builder. Preferably, the automatic dishwashing detergent composition is in the form of a gel comprising from about 2% to about 20%, preferably from 5% to 15% by weight of an alkanolamine, at least about 5% by weight of detergency builder, and from about 0.1% to about 5% by weight of a low foaming non-ionic surfactant. Although any non-ionic low foaming surfactant (or combination of non-ionic surfactants and suds suppressers) can be used herein, capped nonionic surfactants and combinations or amine oxide and capped non-ionic surfactants are preferred. The compositions also preferably have a pH (1% aqueous solution) in excess of about 9.0, preferably in excess of about 10.5 and more preferably greater than about 11.

In one embodiment, an automatic dishwashing detergent composition comprises from about 0.05% to about 10% by weight of a low-foaming non-ionic surfactant, from about 1% to about 30% of an organic solvent, preferably alkanolamine solvent, at least about 5% by weight of a detergency builder and a wetting agent, preferably a siliconepoly (alkyleneoxide) copolymers.

In a preferred embodiment, an automatic dishwashing detergent pack is provided, comprising: i) an organic solvent composition suitable for use in automatic dishwashing comprising from about 1% to about 99%, preferably from about 5% to about 90%, especially from about 40% to about 80% of an organic solvent system for removing cooked-, baked-, or burnt-on food soil from cookware and tableware, from about 0.5% to about 50%, preferably from about 5% to about 25% of bleach, from about 0.0001% to about 10% of detergency enzyme, and wherein the composition is in the form of an anhydrous gel comprising bleach in the form of a particulate suspension, and ii) an automatic dishwashing detergent composition comprising from about 0.05% to about 10% by weight of a low-foaming non-ionic surfactant, optionally from about 1% to about 30% of an organoamine, preferably alkanolamine solvent, and at least about 5% by weight of a detergency builder. Preferably, the automatic dishwashing detergent composition is in the form of a gel comprising from about 2% to about 20%, preferably from about 5% to about 15% by weight of the composition of an alkanolamine, at least about 5% by weight of detergency builder (such as sodium potassium tripolyphosphate), and from about 0.1% to about 5% by weight of the composition of a low foaming nonionic surfactant.

The invention also relates to hard-surface cleaning and dishwashing pretreatment compositions comprising the herein defined solvent systems for direct application to burnt-on and baked-on food soiled cookware and tableware. Preferred are compositions comprising an organic solvent system having a liquid surface tension of less than about 27 mN/m. Also preferred are compositions in the form of a liquid or gel and having a pH of greater than about 10.5, preferably greater than about 11. Preferred compositions contain from about 1% to about 99% preferably from about 5% to about 50% of organic solvent as herein defined, highly preferred being a mixed solvent system based on alkanolamine and a mixed glycol ether solvent system as described hereinabove.

The present invention also provides a hard-surface cleaning or dishwashing pretreatment composition for removing cooked-, baked-, or burnt-on food soil from cookware and tableware, the composition comprising an organic solvent system having an advancing contact angle on a polymerised grease-coated substrate of less than 20, preferably less than 10 and more preferably less than 5. Preferably, the hard-surface cleaning composition comprises an organic solvent system comprising a plurality of solvent components in levels such that the composition has an advancing contact angle on polymerised grease of less than that of any of the corresponding compositions containing the individual components of the solvent system.

The invention is further summarized in the following paragraphs:
1. Method for increasing the solubility of an enzyme in a liquid detergent composition comprising one or more enzymes, an anionic surfactant and a solvent system, which liquid detergent composition has a Hansen Solubility Parameter hydrogen bonding contribution (δh) in the range of 2-35.
2. Method according to paragraph 1, wherein the Hansen Solubility Parameter hydrogen bonding contribution (δh) is in the range of 2-35, in the range of 3-30, in the range of 4-29, in the range of 4-28, in the range of 5-26, in the range of 5-25, in the range of 6-25, in the range of 6-25 in the range of 6-20 or in the range 8-18; 10-18; or in the range of 12-18.
3. Method according to any of the preceding paragraphs, wherein the solvent system has a Hansen Solubility parameter hydrogen bonding parameter contribution (δh) in the range of 4-30.
4. Method according to any of the preceding paragraphs, wherein the solvent system has a Hansen Solubility parameter hydrogen bonding parameter contribution (δh) in the range of 4-25, in the range of 4-20, in the range of 5-16, in the range of 6-15, or in the range of 8-15.
5. Method according to any of the preceding paragraphs, wherein solvent system has a Hansen Solubility parameter (δ) in the range of 3-20
6. Method according to any of the preceding paragraphs, wherein the solvent system has a Hansen Solubility parameter (δ) in the range of 5-18, in the range of 6-15, in the range of 9-15 or in the range of 10-17.
7. Method according to any of the preceding paragraphs, wherein the solvent system comprises solvents selected from the group consisting of water, alcohols, polyols, sugars and/or mixtures thereof.
8. Method according to any of paragraphs 1-7, wherein the polyol is selected from the group consisting of glycerol, sorbitol, propylene glycol (MPG), 1,2-propanediol, 1,3-propane diol, dipropylene glycol (DPG), polyethylene glycol family (PEG300-600), hexylene glycol, inositol and mannitol.
9. Method according to any of paragraphs 1-7, wherein the alcohol is selected from the group consisting of ethanol, isopropanol, n-butoxy propoxy propanol and ethanolamines such as monoethanol amine diethanol amines and triethanol amines.
10. Method according to any of paragraphs 1-7, wherein the sugar is selected from the group consisting of sucrose, dextrose, glucose, ribose, xylose and related mono and di pyranosides and furanosides.
11. Method according to any of the preceding paragraphs, wherein the detergent comprises in the range of 5-60%, such as 5-40% or 10-30% of a solvent system.
12. Method according to any of the preceding paragraphs, wherein the anionic surfactant is selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid fatty acids and/or salt of fatty acids and mixtures thereof.
13. Method according to any of the preceding paragraphs, wherein the detergent composition comprises 0.1-60% of anionic surfactant in total.
14. Method according to any of the preceding paragraphs, wherein the detergent composition comprises 5-50% of anionic surfactant in total, 5-30% of anionic surfactant in total, 5-15% of anionic surfactant in total, 15-20% of anionic surfactant in total or 20-25% of anionic surfactant in total.
15. Method according to any of the preceding paragraphs wherein the water content is below 15%, such as below 12%.
16. Method according to any of the preceding paragraphs wherein the water content is below 11%, below 10%, below 9%, below 8%, below 7%, below 6%, below 5%, below 4%, below 3%, below 2% or below 1%,
17. Method according to any of the preceding paragraphs, wherein no water is present in the liquid detergent composition.
18. Method according to any of the preceding paragraphs, wherein the enzyme having increased solubility is selected from the group consisting of protease, lipase, cutinase, amylase, carbohydrase, cellulase, pectate lyase, pectinase, mannanase, arabinase, galactanase, and/or xylanase.
19. Method according to paragraph 18, wherein the enzyme is a protease having at least 90%, such as at least 95% or 99% sequence identity to SEQ ID NO: 15.
20. Method according to any of the preceding paragraphs, wherein the enzyme having increased solubility is a lipase of bacterial or fungal origin or wherein the lipase is chemically modified or protein engineered.
21. Method according to any of the preceding paragraphs, wherein the lipase is derived from Thermomyces, e.g. from T. lanuginosus, cutinase from Humicola, e.g. H. insolens, strains of Pseudomonas, e.g. P. alcaligenes or P. pseudoalcaligenes, P. cepacia, P. sp. strain SD705, P. wisconsinensis, GDSL-type Streptomyces lipases, cutinase from Magnaporthe grisea, cutinase from Pseudomonas mendocina, Thermobifida fusca, Geobacillus stearothermophilus, Bacillus subtilis, Streptomyces griseus and S. pristinaespiralis.
22. Method according to any of paragraphs 1-18 and 20-21, wherein the enzyme is a lipase variant, comprising a substitution at one or more positions corresponding to positions T37A,D,E,F,G,H,I,L,N,P,Q,R,S,V,W,Y, N39A,C,D,E,F,G,I,K,L,M,P,Q,R,T,V,W,Y, and G91D,H,I,P,Q of the mature polypeptide of SEQ ID NO: 2, wherein the variant has lipase activity.
23. Method according to any of paragraphs 1-18 and 22, which is a variant of a parent lipase selected from the group consisting of:
   a. a polypeptide having at least 60% sequence identity to the mature polypeptide of SEQ ID NO: 2;
   b. a polypeptide encoded by a polynucleotide that hybridizes under low stringency conditions with (i) the mature polypeptide coding sequence of SEQ ID NO: 1, or (ii) the full-length complement of (i);
   c. a polypeptide encoded by a polynucleotide having at least 60% identity to the mature polypeptide coding sequence of SEQ ID NO: 1; and
   d. a fragment of the mature polypeptide of SEQ ID NO: 2, which has lipase activity.
24. Method according to any of paragraphs 1-18 and 22-23, which has at least 60%, at least 65%, at least 70%, at least 75%, at least 80%, at least 85%, at least 90%, at least 95%, at least 96%, at least 97%, at least 98%, or at least 99%, but less than 100%, sequence identity to the amino acid sequence of the parent lipase.
25. Method according to any of paragraphs 1-18 and 22-24, wherein the number of substitutions is 1-20, e.g., 1-10 and 1-5, such as 1, 2, 3, 4, 5, 6, 7, 8, 9, 10, 11, 12, 13, 14, 15, 16, 17, 18, 19 or 20 substitutions.
26. Method according to any of paragraphs 1-18 and 22-25, which further comprises a substitution at one or more positions corresponding to positions D96, T143, A150, E210, G225, T231, N233 and P250.
27. Method according to any of paragraphs 1-18 and 22-26, wherein the substitution is selected from D96G, T143A, A150G, E210Q, G225R, T231R, N233R and P250R.
28. Method according to any of paragraphs 1-18 and 22-27, wherein said variant is:
   a. G91Q+T143A+E210Q+T231R+N233R+P250R;
   b. G91Q+A150G+E210Q+T231R+N233R+P250R;
   c. T37R+N39R+G91A+D96G+T231R+N233R;
   d. G91Q+E210Q+T231R+N233R+P250R; or
   e. G91I+E210Q+T231R+N233R+P250R;
29. Method according to any of paragraphs 1-18 and 22-28, wherein said variant is:
   a. G91A+D96G+T231R+N233R;
   b. G91A+D96G+G225R+T231R+N233R;
   c. G91N+E210Q+T231R+N233R+P250R;
   d. G91L+E210Q+T231R+N233R; or
   e. G91A+D96G+A150G+T231R+N233R; or
   f. T231R+N233R
30. Method according to any of paragraphs 1-18 and 22-29, which in comparison with the parent lipase has improved performance in the presence of an organic catalyst selected from the group consisting of organic catalysts having the following formulae:

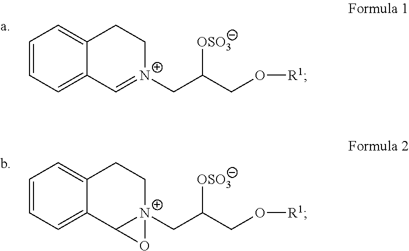

or
   c. mixtures thereof,
   wherein each R1 is independently a branched alkyl group containing from 3 to 24 carbons or a linear alkyl group containing from 1 to 24 carbons; and recovering the variant.
31. Method according to any of paragraphs 1-18 and 22-30, wherein R1 is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl, and iso-pantadecyl.
32. Method according to any of paragraphs 1-18, wherein the enzyme having increased solubility is an alpha-amylase or a glucoamylase of bacterial or fungal origin.
33. Method according to any of paragraphs 1-18 and 32, wherein the alpha-amylase or the glucoamylase is chemically modified or protein engineered.
34. Method according to any of paragraphs 1-18 and 32-33, wherein the amylase is selected from the group consisting of
   a. amylases having SEQ ID NO: 3 or variants having 90% sequence identity to SEQ ID NO: 3 thereof,
   b. amylase variants of SEQ ID NO: 3 with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444,
   c. amylases having SEQ ID NO: 4 or variants thereof having 90% sequence identity to SEQ ID NO: 4, preferred variants of SEQ ID NO: 4 are those having a deletion in positions 181 and 182 and a substitution in position 193,
   d. an amylase having at least 90%, such as at least 95%, sequence identity to the hybrid polypeptide of SEQ ID NO: 5: or variants having 90% sequence identity thereof, preferred variants are those having a substitution, a deletion or an insertion in one of more of the following positions: G48, T49, G107, H156, A181, N190, M197, I201, A209, Q264, M197T; H156Y+A181T+N190F+A209V+Q264S; or G48A+T49I+G107A+H156Y+A181T+N190F+I201F+A209V+Q264S;
   e. amylases having SEQ ID NO: 6 or variants thereof having 90% sequence identity to SEQ ID NO: 6, preferred variants of SEQ ID NO: 6 are those having a substitution, a deletion or an insertion in one or more of the following positions: R181, G182, H183, G184, N195, 1206, E212, E216 and K269. particularly preferred amylases are those having deletion in positions R181 and G182, or positions H183 and G184,
   f. amylases having SEQ ID NO: 7, SEQ ID NO: 8 or SEQ ID NO: 9 or variants thereof having 90% sequence identity to SEQ ID NO: 7, SEQ ID NO: 8 or SEQ ID NO: 9; preferred variants of SEQ ID NO: 7, SEQ ID NO: 8 or SEQ ID NO: 9 are those having a substitution, a deletion or an insertion in one or more of the following positions: 140, 181, 182, 183, 184, 195, 206, 212, 243, 260, 269, 304 and 476; more preferred variants are those having a deletion in positions 181 and 182 or positions 183 and 184, most preferred amylase variants of SEQ ID NO: 7, SEQ ID NO: 8 or SEQ ID NO: 9 are those having a deletion in positions 183 and 184 and a substitution in one or more of positions 140, 195, 206, 243, 260, 304 and 476,
   g. amylases having SEQ ID NO: 10, or variants thereof having 90% sequence identity to SEQ ID NO: 10,
   h. amylases having SEQ ID NO: 11, or variants thereof having 90% sequence identity to SEQ ID NO: 11,
   i. amylases having SEQ ID NO: 12 or variants having 90% sequence identity to SEQ ID NO: 12 thereof, preferred variants of SEQ ID NO: 12 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475, more preferred variants of SEQ ID NO: 12 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183, even more preferred amylase variants of SEQ ID NO: 12 are those having the substitutions:
      N128C+K178L+T182G+Y305R+G475K;
      N128C+K178L+T182G+F202Y+Y305R+D319T+G475K;
      S125A+N128C+K178L+T182G+Y305R+G475K; or
      S125A+N128C+T131I+T165I+K178L+T182G+Y305R+G475K, wherein the variants are C-terminally truncated and optionally further comprises a substitution at position 243 and/or a deletion at position 180 and/or position 181,
   j. alpha-amylase having SEQ ID NO: 13 or a variant having at least 90% sequence identity to SEQ ID NO: 13, preferred amylase variants are those having a substitution, a deletion or an insertion in one of more of the following positions of SEQ ID NO: 13: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484, particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions, and
   k. amylase having SEQ ID NO: 14 or a variant having at least 90% sequence identity to SEQ ID NO: 14
35. Method according to any of the preceding paragraphs, wherein the enzyme having increased solubility is used in combination with at least one additional enzyme.
36. Method according to paragraph 35, wherein the additional enzyme is selected from the group consisting of protease, lipase, cutinase, amylase, carbohydrase, cellulase, pectate lyase, pectinase, mannanase, arabinase, galactanase, and/or xylanase.
37. Method according to any of preceding paragraphs, wherein the concentration of the enzyme exhibiting increased solubility is in the range of 0.001-5 mg enzyme per gram detergent composition.
38. Method according to any of preceding paragraphs, wherein the concentration of the enzyme exhibiting increased solubility is in the range of 0.005-1 mg enzyme per gram detergent composition, in the range of 0.008-0.6 mg enzyme per gram detergent composition, in the range of 0.01-0.5 mg enzyme per gram detergent composition or in the range of 0.02-0.3 mg enzyme per gram detergent composition.
39. A liquid detergent composition comprising one or more enzymes, an anionic surfactant and a solvent system, which liquid detergent composition has a Hansen Solubility Parameter hydrogen bonding contribution (δh) in the range of 2-35.
40. Detergent composition according to paragraph 39, wherein the Hansen Solubility Parameter hydrogen bonding contribution (δh) is in the range of 2-35, in the range of 3-30, in the range of 4-29, in the range of 4-28, in the range of 5-26, in the range of 5-25, in the range of 5-25, in the range of 6-25, in the range of 6-25 or in the range of 6-20.
41. Detergent composition according to any of paragraphs 39-40, wherein the solvent system has a Hansen Solubility parameter hydrogen bonding parameter contribution (δh) in the range of 4-30.
42. Detergent composition according to any of paragraphs 39-41, wherein the solvent system has a Hansen Solubility parameter hydrogen bonding parameter contribution (δh) in the range of 4-25, in the range of 4-20, in the range of 5-16 or in the range of 6-15.
43. Detergent composition according to any of paragraphs 39-40, wherein solvent system has a Hansen Solubility parameter (δ) in the range of 3-20.
44. Detergent composition according to any of paragraphs 39-40, wherein the solvent system has a Hansen Solubility parameter (δ) in the range of 5-18, in the range of 6-15 or in the range of 9-15.
45. Detergent composition according to any of paragraphs 39-44, wherein the solvent system comprises solvents selected from the group consisting of water, alcohols, polyols sugars and/or mixtures thereof.
46. Detergent composition according to any of paragraphs 39-45, wherein the polyol is selected from the group consisting of glycerol, sorbitol, propylene glycol (MPG), 1,2-propanediol, 1,3-propane diol, dipropylene glycol (DPG), polyethylene glycol family (PEG300-600), hexylene glycol, inositol and mannitol.
47. Detergent composition according to any of paragraphs 39-46, wherein the alcohol is selected from the group consisting of ethanol, isopropanol, n-butoxy propoxy propanol and ethanolamines such as monoethanol amine diethanol amines and triethanol amines.
48. Detergent composition according to any of paragraphs 39-47, wherein the sugar is selected from the group consisting of sucrose, dextrose, glucose, ribose, xylose and related mono and di pyranosides and furanosides.
49. Detergent composition according to any of paragraphs 39-48, wherein the detergent comprises in the range of 5-60%, such as 5-40% or 10-30% of a solvent system.
50. Detergent composition according to any of paragraphs 39-49, wherein the anionic surfactant selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid and/or salt of fatty acids.
51. Detergent composition according to any of paragraphs 39-50, wherein the detergent composition comprises 0.1-60% of anionic surfactant in total.
52. Detergent composition according to any of paragraphs 39-51, wherein the detergent composition comprises 5-50% of anionic surfactant in total, 5-30% of anionic surfactant in total, 5-15% of anionic surfactant in total, 15-20% of anionic surfactant in total or 20-25% of anionic surfactant in total.
53. Detergent composition according to any of paragraphs 39-52, wherein the water content is below 15%, such as below 12%.
54. Detergent composition according to any of paragraphs 39-53, wherein the water content is below 11%, below 10%, below 9%, below 8%, below 7%, below 6%, below 5%, below 4%, below 3%, below 2% or below 1%,
55. Detergent composition according to any of paragraphs 39-54, wherein no water is present in the liquid detergent composition.
56. Detergent composition according to any of paragraphs 39-55, wherein the wherein the enzyme is selected from the group consisting of protease, lipase, cutinase, amylase, carbohydrase, cellulase, pectate lyase, pectinase, mannanase, arabinase, galactanase, and/or xylanase.
57. Detergent composition according to any of paragraphs 39-56, wherein the enzyme is a lipase of bacterial or fungal origin.
58. Detergent composition according to any of paragraphs 39-57, wherein the lipase is chemically modified or protein engineered.
59. Detergent composition according to any of paragraphs 39-58, wherein the lipase is derived from Thermomyces, e.g. from T. lanuginosus, cutinase from Humicola, e.g. H. insolens, strains of Pseudomonas, e.g. P. alcaligenes or P. pseudoalcaligenes, P. cepacia, P. sp. strain SD705, P. wisconsinensis, GDSL-type Streptomyces lipases, cutinase from Magnaporthe grisea, cutinase from Pseudomonas mendocina, Thermobifida fusca, Geobacillus stearothermophilus, Bacillus subtilis, Streptomyces griseus and S. pristinaespiralis.
60. Detergent composition according to any of paragraphs 39-56, wherein the enzyme is a lipase variant, comprising a substitution at one or more positions corresponding to positions T37A,D,E,F,G,H,I,L,N,P,Q,R,S,V,W,Y, N39A,C,D,E,F,G,I,K,L,M,P,Q,R,T,V,W,Y, and G91D,H,I,P,Q of the mature polypeptide of SEQ ID NO: 2, wherein the variant has lipase activity.
61. Detergent composition according to any of paragraphs 39-56 and 60, which is a variant of a parent lipase selected from the group consisting of:
   a. a polypeptide having at least 60% sequence identity to the mature polypeptide of SEQ ID NO: 2;
   b. a polypeptide encoded by a polynucleotide that hybridizes under low stringency conditions with (i) the mature polypeptide coding sequence of SEQ ID NO: 1, or (ii) the full-length complement of (i);
   c. a polypeptide encoded by a polynucleotide having at least 60% identity to the mature polypeptide coding sequence of SEQ ID NO: 1; and
   d. a fragment of the mature polypeptide of SEQ ID NO: 2, which has lipase activity.
62. Detergent composition according to any of paragraphs 39-56 and 60-61, which has at least 60%, at least 65%, at least 70%, at least 75%, at least 80%, at least 85%, at least 90%, at least 95%, at least 96%, at least 97%, at least 98%, or at least 99%, but less than 100%, sequence identity to the amino acid sequence of the parent lipase.
63. Detergent composition according to any of paragraphs 39-56 and 60-62, wherein the number of substitutions is 1-20, e.g., 1-10 and 1-5, such as 1, 2, 3, 4, 5, 6, 7, 8, 9, 10, 11, 12, 13, 14, 15, 16, 17, 18, 19 or 20 substitutions.
64. Detergent composition according to any of paragraphs 39-56 and 60-63, which further comprises a substitution at one or more positions corresponding to positions D96, T143, A150, E210, G225, T231, N233 and P250.
65. Detergent composition according to any of paragraphs 39-56 and 60-64, wherein the substitution is selected from D96G, T143A, A150G, E210Q, G225R, T231R, N233R and P250R.
66. Detergent composition according to any of paragraphs 39-56 and 60-65, wherein said variant is:
   a. G91Q+T143A+E210Q+T231R+N233R+P250R;
   b. G91Q+A150G+E210Q+T231R+N233R+P250R;
   c. T37R+N39R+G91A+D96G+T231R+N233R;
   d. G91Q+E210Q+T231R+N233R+P250R; or
   e. G91I+E210Q+T231R+N233R+P250R;
67. Detergent composition according to any of paragraphs 39-56 and 60-66, wherein said variant is:
   a. G91A+D96G+T231R+N233R;
   b. G91A+D96G+G225R+T231R+N233R;
   c. G91N+E210Q+T231R+N233R+P250R;
   d. G91L+E210Q+T231R+N233R; or
   e. G91A+D96G+A150G+T231R+N233R.
68. Detergent composition according to any of paragraphs 39-56 and 60-67, which in comparison with the parent lipase has improved performance in the presence of an organic catalyst selected from the group consisting of organic catalysts having the following formulae:

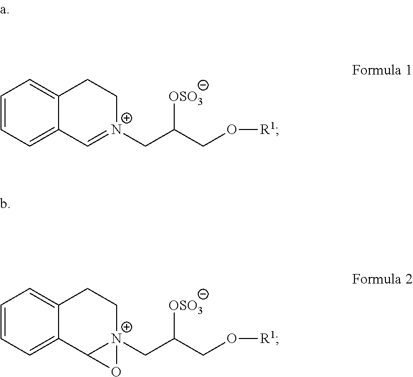

or
   c. mixtures thereof,
   wherein each R1 is independently a branched alkyl group containing from 3 to 24 carbons or a linear alkyl group containing from 1 to 24 carbons; and recovering the variant.
69. Detergent composition according to any of paragraphs 39-56 and 60-68, wherein R1 is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl, and iso-pantadecyl.
70. Detergent composition according to any of paragraphs 39-56, wherein the enzyme is an alpha-amylase or a glucoamylase of bacterial or fungal origin.
71. Detergent composition according to any of paragraphs 39-56 and 70, wherein the alpha-amylase or the glucoamylase is chemically modified or protein engineered.
72. Detergent composition according to any of paragraphs 39-71, wherein the amylase is selected from the group consisting of
   a. amylases having SEQ ID NO: 3 or variants having 90% sequence identity to SEQ ID NO: 3 thereof,
   b. amylase variants of SEQ ID NO: 3 with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444,
   c. amylases having SEQ ID NO: 4 or variants thereof having 90% sequence identity to SEQ ID NO: 4, preferred variants of SEQ ID NO: 4 are those having a deletion in positions 181 and 182 and a substitution in position 193,
   d. an amylase having at least 90%, such as at least 95%, sequence identity to the hybrid polypeptide of SEQ ID NO: 5: 5,
      or variants having 90% sequence identity thereof, preferred variants are those having a substitution, a deletion or an insertion in one of more of the following positions: G48, T49, G107, H156, A181, N190, M197, I201, A209, Q264, M197T; H156Y+A181T+N190F+A209V+Q264S; or G48A+T49I+G107A+H156Y+A181T+N190F+I201F+A209V+Q264S;
   e. amylases having SEQ ID NO: 6 or variants thereof having 90% sequence identity to SEQ ID NO: 6, preferred variants of SEQ ID NO: 6 are those having a substitution, a deletion or an insertion in one or more of the following positions: R181, G182, H183, G184, N195, 1206, E212, E216 and K269. particularly preferred amylases are those having deletion in positions R181 and G182, or positions H183 and G184,
   f. amylases having SEQ ID NO: 7, SEQ ID NO: 8 or SEQ ID NO: 9 or variants thereof having 90% sequence identity to SEQ ID NO: 7, SEQ ID NO: 8 or SEQ ID NO: 9; preferred variants of SEQ ID NO: 7, SEQ ID NO: 8 or SEQ ID NO: 9 are those having a substitution, a deletion or an insertion in one or more of the following positions: 140, 181, 182, 183, 184, 195, 206, 212, 243, 260, 269, 304 and 476; more preferred variants are those having a deletion in positions 181 and 182 or positions 183 and 184, most preferred amylase variants of SEQ ID NO: 7, SEQ ID NO: 8 or SEQ ID NO: 9 are those having a deletion in positions 183 and 184 and a substitution in one or more of positions 140, 195, 206, 243, 260, 304 and 476,
   g. amylases having SEQ ID NO: 10, or variants thereof having 90% sequence identity to SEQ ID NO: 10,
   h. amylases having SEQ ID NO: 11, or variants thereof having 90% sequence identity to SEQ ID NO: 11,
   i. amylases having SEQ ID NO: 12 or variants having 90% sequence identity to SEQ ID NO: 12 thereof, preferred variants of SEQ ID NO: 12 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475, more preferred variants of SEQ ID NO: 12 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183, even more preferred amylase variants of SEQ ID NO: 12 are those having the substitutions:
      N128C+K178L+T182G+Y305R+G475K;
      N128C+K178L+T182G+F202Y+Y305R+D319T+G475K;
      S125A+N128C+K178L+T182G+Y305R+G475K; or
      S125A+N128C+T131I+T165I+K178L+T182G+Y305R+G475K, wherein the variants are C-terminally truncated and optionally further comprises a substitution at position 243 and/or a deletion at position 180 and/or position 181,
   j. alpha-amylase having SEQ ID NO: 13 or a variant having at least 90% sequence identity to SEQ ID NO: 13, preferred amylase variants are those having a substitution, a deletion or an insertion in one of more of the following positions of SEQ ID NO: 13: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484, particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions, and
   k. amylase having SEQ ID NO: 14 or a variant having at least 90% sequence identity to SEQ ID NO: 14.
73. Detergent composition according to any of paragraphs 39-72, wherein the enzyme wherein the enzyme is a protease having at least 90%, such as at least 95% or 99% sequence identity to SEQ ID NO: 15.
74. Detergent composition according to any of paragraphs 39-73, wherein the enzyme is used in combination with at least one additional enzyme selected from the group consisting of protease, lipase, cutinase, amylase, carbohydrase, cellulase, pectate lyase, pectinase, mannanase, arabinase, galactanase, and/or xylanase.
75. Detergent composition according to any of paragraphs 39-74, wherein the concentration of the enzymes are in the range of 0.001-5 mg enzyme per gram detergent composition.
76. Detergent composition according to any of paragraphs 39-75, wherein the concentration of the enzymes are in the range of 0.005-1 mg enzyme per gram detergent composition, in the range of 0.008-0.6 mg enzyme per gram detergent composition, in the range of 0.01-0.5 mg enzyme per gram detergent composition or in the range of 0.02-0.3 mg enzyme per gram detergent composition.
77. A detergent multi-compartment pouch having a plurality of water-soluble films forming a plurality of compartments the pouch comprising two side-by-side compartments superposed onto another compartment wherein at least two different compartments contain two different compositions, which multi-compartment pouch comprises the liquid detergent composition of paragraphs 39-76.
78. A detergent pouch according to paragraph 77 wherein one of the compartments contains a composition in liquid form and another compartment contains a composition in solid form wherein the solid and liquid compositions are in a weight ratio of from about 20:1 to about 1:20.
79. A detergent pouch according to any of paragraphs 77 or 78 wherein the two side-by-side compartments contain liquid compositions and another compartment contains a solid composition.
80. A detergent pouch according to any of paragraphs 77-79 wherein the pouch has a volume of from about 10 ml to about 30 ml and preferably the weight of the solid composition is from about 10 to about 26 grams and the weight of the liquid composition is from about 0.5 to about 4 grams.
81. A detergent pouch according to any of paragraphs 77-80 wherein at least two of the films have different solubility.
82. A detergent pouch according to any of paragraphs 77-81 wherein at least one composition comprises an enzyme and another composition comprises a bleach and preferably one of the films that form the compartment containing the enzyme-containing composition has a solubility such as it releases its contents prior to the films that form the compartment containing the bleach-containing composition in the main-wash cycle of an automatic dishwashing machine.
83. Use of a detergent composition of paragraphs 77-82 for removing or releasing a stain from a textile having a stain.
84. Textile washed with the detergent of paragraphs 39-76.

### Assays

### Wash Assays

Wash conditions in various regions for normal heavy duty wash***

| | Latin | | North | | | | Asia excl. | | | |
|---|---|---|---|---|---|---|---|---|---|---|
| Region | America | | America | | Europe | | Japan | | Japan | |
| Temperature | 20-25° | C. | 16-32° | C. | 30-60° | C. | 15-30° | C. | 15-20° | C. |
| Main Wash time | 14-16 | min | 12 | min | 20-40 | min | 14-20 | min | 9 | min |
| Total wash time | 55 | min | 50 | min | 90-120 | min | 60 | min | 45-50 | min |
| Water hardness* | 6-12° | dH | 6°-8,4 | dH | 15° | dH | 14° | dH | 3° | dH |
| Detergent dosage | 1.5-4 | g/l | 1.0-1.5 | g/l | 4-10 | g/l | 1.5-2.5 | g/l | 0.5-0.7 | g/l |

| | | | | | |
|---|---|---|---|---|---|
| Washing pH | As it is | As it is | As it is | As it is | As it is |

*°dH: adjusted by adding CaCl₂*2H₂O, MgCl₂*6H₂O and NaHCO₃ to Milli-Q water.
Note
(this is estimations and not absolutes, there is speciel conditions for different regions and also with different machines)

### Launder-O-Meter (LOM) Model Wash System

The Launder-O-Meter (LOM) is a medium scale model wash system that can be applied to test up to 20 different wash conditions simultaneously. A LOM is basically a large temperature controlled water bath with 20 closed metal beakers rotating inside it. Each beaker constitutes one small washing machine and during an experiment, each will contain a solution of a specific detergent/enzyme system to be tested along with the soiled and unsoiled fabrics it is tested on. Mechanical stress is achieved by the beakers being rotated in the water bath and by including metal balls in the beaker.

The LOM model wash system is mainly used in medium scale testing of detergents and enzymes at European wash conditions. In a LOM experiment, factors such as the ballast to soil ratio and the fabric to wash liquor ratio can be varied. Therefore, the LOM provides the link between small scale experiments, such as AMSA and mini-wash, and the more time consuming full scale experiments in front loader washing machines.

### Terg-O-Tometer (TOM) Wash Assay

The Tergo-To-Meter (TOM) is a medium scale model wash system that can be applied to test 12 different wash conditions simultaneously. A TOM is basically a large temperature controlled water bath with up to 12 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker. Because the TOM beakers have no lid, it is possible to withdraw samples during a TOM experiment and assay for information on-line during wash.

The TOM model wash system is mainly used in medium scale testing of detergents and enzymes at US or LA/AP wash conditions. In a TOM experiment, factors such as the ballast to soil ratio and the fabric to wash liquor ratio can be varied. Therefore, the TOM provides the link between small scale experiments, such as AMSA and mini-wash, and the more time consuming full scale experiments in top loader washing machines.

Equipment: The water bath with 12 steel beakers and 1 rotating arm per beaker with capacity of 500 or 1200 mL of detergent solution. Temperature ranges from 5 to 80° C. The water bath has to be filled up with deionised water. Rotational speed can be set up to 70 to 120 rpm/min.
1. Set temperature in the Terg-O-Tometer and start the rotation in the water bath. Wait for the temperature to adjust (tolerance is +/−0.5° C.).
2. All beakers shall be clean and without traces of prior test material.
3. Prepare wash solution with desired amount of detergent, temperature and water hardness in a bucket. Let detergent dissolve during magnet stirring for 10 min. Wash solution shall be used within 30 to 60 min after preparation.
4. Add 800 ml wash solution into a TOM beaker.
5. Start agitation at 120 rpm and optionally add enzymes to the beaker.
6. Sprinkle the swatches into the beaker and then the ballast load.
7. Time measurement start when the swatches and ballast are added to the beaker.
8. Wash for 20 minutes.
9. Stop agitation.
10. Transfer the wash load from TOM beaker to a sieve and rinse with cold tap water.
11. Separate the soil swatches from the ballast load. The soil swatches are transferred to a 5 L beaker with cold tap water under running water. Keep the ballast load separately for the coming inactivation.
12. Set the timer to 5 minutes.
13. Press gently the water out by hand and place the test swatches on a tray covered with a paper. Add another paper on top of the swatches.
14. Let the swatches dry over night and then measure at the Color Eye as described above (ΔRem value).

### Measuring Overall Hansen Solubility Parameter the Partial Contributions (δ; δh, δp, δ d)

Hansen solubility parameters and the δh, δd, δp contributions can be measured by analytical institues skilled in the art, ex Agfa Labs by a multiple solution approach in a high throughput workflow, making use of a relevant subset out of the original library of 88 test solutions. The workflow comprises precise formulation, mixing and analytical measurement of solubility (not just “by the eye”). The HSP parameters of the material are derived from the solubility results in up to 58 test solutions in a fast, correct and cost efficient way.

HSPiP software version 4.0.03 or used the library values in the software data package which uses an unpublished proprietary algorithm that is based on values published in the Handbook of solubility Parameters and other parameters by Allan F M Barton (CRC Press 1983) for solvents obtained experimentally by Hansen.

TABLE 1 of Hansen solubility parameters and the δh, δd, δp contributions calculated by the HSPiP software or experimentally obtained and listed in Hansen Solubility parameters—a users handbook:

| | | HSPIP data excell HSPiP 4.0.03 | | | | |
|---|---|---|---|---|---|---|
| compound | SMILES | entry | δd | δp | δh | δ |
| Propylene glycol | CC(O)CO | 585 | 16.8 | 10.4 | 21.3 | 29.1 |
| (1,2-propanediol) | | | | | | |
| 1,3-propanediol | C(CO)CO | 1038 | 16.8 | 13.5 | 23.2 | 31.7 |
| Glycerol | C(C(CO)O)O | 406 | 17.4 | 11.3 | 27.2 | 34.2 |
| sorbitol | O[C@H](CO)[C@@H](O)[C@H](O) | 7590 | 17.3 | 12.8 | 44.8 | 49.7 |
| | [C@@H](O)CO | | | | | |
| sucrose | O[C@H](C(CO)O[C@H](O[C@@]2(O | 8073 | 18.3 | 19.8 | 54.6 | 60.89 |
| | [C@H](CO)[C@@H](O)[C@@H]2O) | | | | | |
| | CO)[C@@H]1O)[C@@H]1O | | | | | |
| Dextrose | O[C@H]1O[C@H](CO)[C@@H](O) | 7589 | 18.7 | 21 | 56.2 | 62.84 |
| | [C@H](O)[C@H]1O | | | | | |
| inositol | C1(C(O)C(C(O)C(C1O)O)O)O | 16720 | 19.1 | 23.2 | 69.8 | 75.99 |
| Water | | 696 | 15.5 | 16 | 42.3 | 47.8 |
| Ethanol | CCO | 325 | 15.8 | 8.8 | 19.4 | 26.5 |
| isopropanol | OC(C)C | 570 | 15.8 | 6.1 | 16.4 | 23.58 |
| Citric Acid | OC(C(O)═O)(CC(O)═O)CC(O)═O | 7123 | 17.7 | 10.4 | 29.9 | 36.3 |
| Ethanolamine | NCCO | 326 | 17 | 15.5 | 21 | 31.1 |
| Diethanolamine | OCCNCCO | 249 | 17.2 | 7 | 19 | 26.6 |
| triethanolamine | OCCN(CCO)CCO | 655 | 17.3 | 7.6 | 21 | 28.2 |
| Sodium Dodecylbenzene | O═S(═O)(O)c1ccc(cc1)CCCCCCCCC | 21776 | 17.8 | 8.3 | 5 | 20.3 |
| sulfonate | CCC | | | | | |
| Stearic acid | CCCCCCCCCCCCCCCCCC(O)═O | 603 | 16.3 | 3.3 | 5.5 | 17.5 |
| Oleic acid | CCCCCCCCC═CCCCCCCCC(═O)O | 545 | 16 | 2.8 | 6.2 | 17.4 |
| sodium lauryl ether | C(OCCOCCOCCCCCCCCCCCC)CO[S] | calculated | 16.5 | 6.9 | 7.5 | 19.4 |
| sulfate | (═O)(═O)[O][Na] | | | | | |
| Sodium dodecyl sulfate | C(CCCCCCCCCC)CO[S](═O)(═O) | 30005 | 16.3 | 10.9 | 7.8 | 21.1 |
| | [O−][Na+] | | | | | |
| Tridecyl alcohol | C(CCCCCCCC)CCCOCCOCCOCCOC | 30007 | 16.4 | 4.6 | 8.3 | 18.95 |
| ethoxylate | COCCOCCOCCO | | | | | |
| Alkyl Alcohol (C13-C15) | C(OCCO)CCCCCCCCCCCC | 30016 | 16.2 | 3.6 | 8.6 | 18.69 |
| ethoxylates | | | | | | |

The overall δh can be calculated as follows: Overall δh=sum (w %*δh ingredient).
The solvent δ can be calculated as follows: Solvent δ=sum solvent (w %*δ solvents).
The solvent δh can be calculated as follows: Solvent δh=sum solvent (w %*δh solvent)
Solvent ingredients are described under definitions.

TABLE 2
Example of calculating the parameters:

| | HSPiP | | | | | Detergent |
|---|---|---|---|---|---|---|
| | 4.0.03 | HSP parameters | | | | 1 |
| | entry no | δd | δp | δh | δ | w % |
| LAS (C9-C15 Alkylbenzene sulfonic acid) | 21776 | 17.8 | 8.3 | 5 | 20.3 | 20% |
| sodium lauryl ether sulfate | calculated | 16.5 | 6.9 | 7.5 | 19.4 | 10% |
| NI C13-7EO | 30007 | 16.4 | 4.6 | 8.3 | 18.9 | 24% |
| Steraric acid | 603 | 16.3 | 3.3 | 5.5 | 17.5 | 11% |
| Ethanolamine | 326 | 17 | 15.5 | 21 | 31.1 | 8% |
| Citric Acid | 7123 | 17.7 | 10.4 | 29.9 | 36.3 | 1% |
| water (single molecule) | 696 | 15.5 | 16 | 42.3 | 47.8 | 6% |
| Ethanol | 325 | 15.8 | 8.8 | 19.4 | 26.5 | |
| MPG | 585 | 16.8 | 10.4 | 21.3 | 29.1 | 20% |
| Glycerol | 406 | 17.4 | 11.3 | 27.2 | 34.2 | |
| Sorbitol | 7590 | 17.3 | 12.8 | 44.8 | 49.7 | |
| SUM weight | | | | | | 100% |
| SUM δ (solvents, polyol, water, ethanolamine) | | | | | | 11.17 |
| SUM δ h (overall) | | | | | | 13.12 |
| SUM δ h (solvents, polyol, water, ethanolamine) | | | | | | 8.48 |

### EXAMPLES

### Example 1

The detergent composition according to the present invention is prepared as set out below and is tested according to the mentioned wash assays.

TABLE 3
Example 1 shows a detergent composition.

| | Detergent 1 |
|---|---|
| | w % |
| LAS (C9-C15 Alkylbenzene sulfonic acid) | 20% |
| sodium lauryl ether sulfate | 10% |
| NI C13-7EO | 24% |
| Steraric acid | 11% |
| Ethanolamine | 8% |
| Citric Acid | 1% |
| water | 6% |
| Ethanol | |
| MPG | 20% |
| Glycerol | |
| Sorbitol | |
| SUM weight | 100% |
| SUM δ (solvents, polyol, water, ethanolamine) | 11.17 |
| SUM δ h (overall) | 13.12 |
| SUM δ h (solvents, polyol, water, ethanolamine) | 8.48 |

General method of preparation for low water detergents: water; polyol; 75% of ethanolamine and stearic acid are mixed and heated to 60° C. until dissolved; LAS; sodium lauryl ether sulfate are added in small portions with full dissolution inbetween keeping pH alkaline with addition of ethanol amine as required. Heat is turned off and nonionic (C13-7EO) is added and dissolved followed by addition of citric acid in small portions and rest of ethanol amine.

### Example 2

The detergent compositions according to the present invention are prepared as set out below and are tested according to the mentioned wash assays.

TABLE 4
Example 2 shows a detergent composition.

| | Detergent 2 | Detergent 3 | Detergent 4 | Detergent 5 | Detergent 6 |
|---|---|---|---|---|---|
| | w % | w % | w % | w % | w % |
| LAS (C9-C15 | 20% | 20% | 20% | 20% | 20% |
| Alkylbenzene | | | | | |
| sulfonic acid) | | | | | |
| sodium lauryl | 10% | 10% | 10% | 10% | 10% |
| ether sulfate | | | | | |
| NI C13-7EO | 24% | 24% | 24% | 24% | 24% |
| Steraric acid | 11% | 11% | 11% | 11% | 11% |
| Ethanolamine | 8% | 8% | 8% | 8% | 8% |
| Citric Acid | 1% | 1% | 1% | 1% | 1% |
| water (single | 6% | 6% | 6% | 6% | 6% |
| molecule) | | | | | |
| Ethanol | | | | | |
| MPG | 20% | 20% | 20% | 20% | 20% |
| Glycerol | | | | | |
| Sorbitol | | | | | |
| Lipase variant | 20 ppm | 0 ppm | 10 ppm | 20 ppm | 40 ppm |
| active protein | | | | | |
| (T231R + | | | | | |
| N233R of SEQ | | | | | |
| ID NO: 2) | | | | | |
| Amylase | 0 ppm | 300 ppm | 300 ppm | 100 ppm | 500 ppm |
| variant active | | | | | |
| protein (SEQ ID | | | | | |
| NO 14) | | | | | |
| Protease | 400 ppm | 0 ppm | 600 ppm | 0 ppm | 400 ppm |
| variant active | | | | | |
| protein (SEQ ID | | | | | |
| NO: 15) | | | | | |
| SUM weight | 100% | 100% | 100% | 100% | 100% |
| SUM δ | 11.17 | 11.17 | 11.17 | 11.17 | 11.17 |
| (solvents, | | | | | |
| polyol, water, | | | | | |
| ethanolamine) | | | | | |
| SUM δ h | 13.12 | 13.12 | 13.12 | 13.12 | 13.12 |
| (overall) | | | | | |
| SUM δ h | 8.48 | 8.48 | 8.48 | 8.48 | 8.48 |
| (solvents, | | | | | |
| polyol, water, | | | | | |
| ethanolamine) | | | | | |

### Example 3

The detergent compositions according to the present invention are prepared as set out below and are tested according to the mentioned wash assays.

| | Detergent 7 | Detergent 8 | Detergent 9 | Detergent 10 |
|---|---|---|---|---|
| | w % | w % | w % | w % |
| LAS (C9-C15 Alkylbenzene | 21% | 17% | 20% | 20% |
| sulfonic acid) | | | | |
| sodium lauryl ether sulfate | 8% | 11% | 10% | 10% |
| NI C13-7EO | 17% | 28% | 20% | 20% |
| Fatty acid (coco acid) | 15% | 4% | 5% | 10% |
| Mono ethanolamine | 8% | 4% | 6% | 7% |
| Citric Acid | 2% | 2% | 2% | 2% |
| water | 8% | 13% | 10% | 10% |
| MPG | 15% | 21% | 20% | 16% |
| Glycerol | 6% | 0% | 7% | 5% |
| SUM | 100% | 100% | 100% | 100% |
| SUM δ (solvents; polyol; | 12.73 | 13.56 | 14.85 | 13.32 |
| water; ethanolamine) | | | | |
| SUM δ h (overall detergent) | 14.38 | 15.63 | 15.94 | 15.03 |
| SUM δ h (solvents; polyol; | 9.89 | 10.81 | 11.65 | 10.47 |
| water; ethanolamine) | | | | |

### Example 4

The detergent compositions according to the present invention are prepared as set out below and are tested according to the mentioned wash assays.

| | Detergent 7 | Detergent 8 | Detergent 9 | Detergent 10 |
|---|---|---|---|---|
| | w % | w % | w % | w % |
| LAS (C9-C15 Alkylbenzene | 21% | 17% | 20% | 20% |
| sulfonic acid) | | | | |
| sodium lauryl ether sulfate | 8% | 11% | 10% | 10% |
| NI C13-7EO | 17% | 28% | 20% | 20% |
| Fatty acid (coco acid) | 15% | 4% | 5% | 10% |
| Mono ethanolamine | 8% | 4% | 6% | 7% |
| Citric Acid | 2% | 2% | 2% | 2% |
| water | 8% | 13% | 10% | 10% |
| MPG | 15% | 21% | 20% | 16% |
| Glycerol | 6% | 0% | 7% | 5% |
| Lipase variant active protein | 20 ppm | 0 ppm | 10 ppm | 20 ppm |
| (T231R + N233R of SEQ ID | | | | |
| NO: 2) | | | | |
| Amylase variant active | 0 ppm | 300 ppm | 300 ppm | 100 ppm |
| protein (SEQ ID NO 14) | | | | |
| Protease variant active | 400 ppm | 0 ppm | 600 ppm | 0 ppm |
| protein (SEQ ID NO: 15) | | | | |
| SUM | 100% | 100% | 100% | 100% |
| SUM δ (solvents; polyol; | 12.73 | 13.56 | 14.85 | 13.32 |
| water; ethanolamine) | | | | |
| SUM δ h (overall detergent) | 14.38 | 15.63 | 15.94 | 15.03 |
| SUM δ h (solvents; polyol; | 9.89 | 10.81 | 11.65 | 10.47 |
| water; ethanolamine) | | | | |

### Example 5

The detergent composition according to the present invention is prepared as set out below and is tested according to the mentioned wash assays.

The detergent composition comprises: linear alkylbenzene sulfonates, C12-16 Pareth-9, propylene, glycol, alcoholethoxy sulfate, water, polyethyleneimine ethoxylate, glycerine, fatty acid salts, PEG-136 polyvinyl acetate, ethylene Diamine disuccinic salt, monoethanolamine citrate, sodium bisulfite, diethylenetriamine pentaacetate, sodium, disodium distyrylbiphenyl disulfonate, calcium formate, mannanase, xyloglucanase, sodium formate, hydrogenated castor oil, Natelase®, dyes, termamyl, protease, benzisothiazolin, perfume.

### Example 6

The detergent composition according to the present invention is prepared with each of the lipase variant and amylase variants as set out below and is tested according to the mentioned wash assays.

The detergent composition comprises: linear alkylbenzene sulfonates, C12-16 Pareth-9, propylene, glycol, alcoholethoxy sulfate, water, polyethyleneimine ethoxylate, glycerine, fatty acid salts, PEG-136 polyvinyl acetate, ethylene Diamine disuccinic salt, monoethanolamine citrate, sodium bisulfite, diethylenetriamine pentaacetate, sodium, disodium distyrylbiphenyl disulfonate, calcium formate, mannanase, xyloglucanase, sodium formate, hydrogenated castor oil, amylase variant/s and; lipase variant as shown in example 2.

### Example 7

The detergent composition according to the present invention is prepared as set out below and is tested according to the mentioned wash assays.

MEA-Dodecylbenzenesulfonate; Propylene Glycol; C12-14 Pareth-7; Aqua; MEA-Laureth Sulfate; MEA-Palm Kernelate; PEI Ethoxylate; Glycerin; MEA Citrate; PARFUM; Dodecylbenzene Sulfonic Acid; Potassium Sulfite; Magnesium Chloride; Disodium Distyrylbiphenyl Disulfonate; PEG/PPG-10/2 Propylheptyl Ether; Hydrogenated Castor Oil; Ethanolamine; Polystyrene; Sodium Formate; Sorbitol; Protease; Tripropylene Glycol; 2-Propenoic acid, polymer with ethenylbenzene; Butylphenyl Methylpropional; Sulfuric Acid

### Example 8

The below detergent compositions were prepared as described

| | Detergent 11 | Detergent 12 | | |
|---|---|---|---|---|
| | w % | w % | Detergent 13 | Detergent14 |
| LAS (C9-C15 Alkylbenzene | 20% | 15% | 14.3% | 13.5% |
| sulfonic acid) | | | | |
| sodium lauryl ether sulfate | 10% | 5% | 4.8% | 4.5% |
| NI C13-7EO | 17% | | | |
| NI C12-C15 7EO | | 45% | 42.8% | 40.5% |
| Oleic Acid | 8% | 15% | 14.3% | 13.5% |
| Ethanolamine | 8% | 7.0% | 6.7% | 6.3% |
| Citric Acid | 2% | 0.1% | 0.1% | 0.1% |
| water | 10% | 7.9% | 7.5% | 7.1% |
| MPG | 10% | 5.0% | 4.8% | 4.5% |
| Glycerol | 10% | | | |
| Sorbitol | 5% | | 3.0% | 5.0% |
| Inositol | | | 2.0% | 5.0% |
| SUM weight | 100% | 100% | 100% | 100% |
| SUM δ (solvents; polyol; | 16.08 | 7.41 | 10.05 | 12.95 |
| water; ethanolamine) | | | | |
| SUM δ h (overall detergent) | 17.26 | 11.83 | 13.98 | 16.38 |
| SUM δ h (solvents; polyol; | 13.00 | 5.88 | 8.32 | 11.02 |
| water; ethanolamine) | | | | |

Solubility of lipase variant G91A+D96G+G225R+T231R+N233R of SEQ ID NO: 2 were determined in detergent 11 and detergent 12. Liquid enzyme products of the lipase was added in different doses and visual appearance in bright light and turbidity (NTU; Hach Laboratory Turbidimeter 2100AN) was evaluated after at least 15 min.

| Detergent 11 added lipase | | | Detergent 12 added lipase | | |
|---|---|---|---|---|---|
| Dose (active | | | Dose (active | | |
| protein) lipase | | | protein) lipase | | |
| variant | visual | NTU | variant | visual | NTU |
| 0 ppm | clear | 1.24 | 0 ppm | clear | 1.41 |
| 1 ppm | clear | 1.92 | 0.5 ppm | clear | 1.59 |
| 5 ppm | clear | 2.48 | 1 ppm | clear | 1.84 |
| 10 ppm | clear | 2.09 | 2 ppm | Light haze | 2.45 |
| 14 ppm | clear | 2.14 | 5 ppm | Light haze | 4.14 |
| 18 ppm | clear | 2.19 | 10 ppm | haze | 5.67 |
| 28 ppm | clear | 2.29 | | | |
| 38 ppm | haze | 3.12 | | | |
| 99 ppm | haze | 3.10 | | | |

Solubility of amylase of SEQ ID NO 14: were determined in detergent 14 and detergent 15. Liquid enzyme products of the lipase was added in different doses and visual appearance in bright light and turbidity (NTU; Hach Laboratory Turbidimeter 2100AN) was evaluated after at least 15 min.

| Detergent 11 added amylase | | | Detergent 12 added amylase | | |
|---|---|---|---|---|---|
| Dose (active | | | Dose (active | | |
| protein) amylase | | | protein) amylase | | |
| variant | visual | NTU | variant | visual | NTU |
| 0 ppm | clear | 1.24 | 0 ppm | clear | 1.41 |
| 3 ppm | clear | 2.28 | 1 ppm | clear | 1.74 |
| 9 ppm | clear | 2.38 | 2 ppm | clear | 2.14 |
| 14 ppm | clear | 2.54 | 3 ppm | Light | 2.38 |
| | | | | haze | |
| 28 ppm | clear | 2.91 | 7 ppm | Light | 3.26 |
| | | | | haze | |
| 42 ppm | clear | 2.86 | 17 ppm | haze | 6.16 |
| 57 ppm | Light | 3.96 | | | |
| | haze | | | | |
| 147 ppm | Light | 3.88 | | | |
| | haze | | | | |

### Example 9

| | δd | δp | δh | δ |
|---|---|---|---|---|
| Lipase variant (T231R + N233R of | 18.23 | 16.8 | 13.53 | 28.24 |
| SEQ ID NO: 2) | | | | |
| spraydried powder | | | | |
| Amylase variant | 18.17 | 16.74 | 13.53 | 28.17 |
| (I181* + G182* + N193F of SEQ ID | | | | |
| NO:) | | | | |
| spraydried powder | | | | |

Purified enzyme concentrates have been spray dried and 10 mg of each is dosed in standard test tubes and 2 ml of each of the 58 screening solvents used is added to separate test tubes and placed on a rolling bench for 24 h followed by visual checked for dissolution. The results are put into the licensed HSPiP software (4^{th} edition; 4.0.08) extracting the above HSP values.

### Example 10

The detergent composition according to the present invention is prepared as set out below and is tested according to the mentioned wash assays.

| | Detergent 13 | Detergent 14 |
|---|---|---|
| | w % | w % |
| LAS (C9-C15 Alkylbenzene | 0% | 5% |
| sulfonic acid) | | |
| sodium lauryl ether sulfate | 0% | 5% |
| NI C13-7EO | 25% | 20% |
| NI C13-C15 7EO | 25% | 20% |
| Oleic Acid | 2% | 2% |
| Ethanolamine | 1.0% | 1.0% |
| Citric Acid | 2.0% | 2.0% |
| water | 14% | 14% |
| MPG | 31% | 31% |
| SUM weight | 100% | 100% |
| SUM δ (solvents; polyol; | 16.01 | 16.01 |
| water; ethanolamine) | | |
| SUM δ h (overall detergent) | 17.68 | 17.46 |
| SUM δ h (solvents; polyol; | 12.74 | 12.74 |
| water; ethanolamine) | | |

1-28. (canceled)

29. A method for increasing the solubility of an enzyme in a liquid detergent composition comprising one or more enzymes, an anionic surfactant and a solvent system, which liquid detergent composition has a Hansen Solubility Parameter hydrogen bonding contribution (δh) in the range of 2-35.

30. The method of claim 29, wherein the solvent system has a Hansen Solubility parameter hydrogen bonding parameter contribution (δh) in the range of 4-30.

31. The method of claim 29, wherein the solvent system comprises solvents selected from the group consisting of water, alcohols, polyols, sugars and/or mixtures thereof.

32. The method of claim 29, wherein the detergent comprises in the range of 5-60% of a solvent system.

33. The method of claim 29, wherein the water content is below 11%.

34. A liquid detergent composition comprising one or more enzymes, an anionic surfactant and a solvent system, which liquid detergent composition has a Hansen Solubility Parameter hydrogen bonding contribution (δh) in the range of 2-35.

35. The detergent composition of claim 34, wherein the Hansen Solubility Parameter hydrogen bonding contribution (δh) is in the range of 3-30.

36. The detergent composition of claim 34, wherein the solvent system has a Hansen Solubility parameter hydrogen bonding parameter contribution (δh) in the range of 4-30.

37. The detergent composition of claim 34, wherein the enzyme having increased solubility is selected from the group consisting of amylase, arabinase, carbohydrase, cellulase, cutinase, galactanase, lipase, mannanase, pectate lyase, pectinase, protease, and/or xylanase.

38. The detergent composition of claim 34, wherein the enzyme having increased solubility is an alpha-amylase or a glucoamylase of bacterial or fungal origin.

39. The detergent composition of claim 34, wherein the enzyme is a protease having at least 90% sequence identity to SEQ ID NO: 15.

40. A detergent multi-compartment pouch having a plurality of water-soluble films forming a plurality of compartments the pouch comprising two side-by-side compartments superposed onto another compartment, wherein at least two different compartments contain two different compositions, which multi-compartment pouch comprises the detergent composition of claim 21.


SEQUENCE LISTING (15 sequences)

SEQ ID NO: 1 - DNA, 873 bp, Thermomyces lanuginosus
  CDS (1)..(873)
  sig_peptide (1)..(51)
  misc_signal (52)..(56)
  mat_peptide (67)..(873)
atgaggagctcccttgtgctgttctttgtctctgcgtggacggccttggccagtcctattcgtcgagaggtctcgcaggatctgtttaaccagttcaatctctttgcacagtattctgcagccgcatactgcggaaaaaacaatgatgccccagctggtacaaacattacgtgcacgggaaatgcctgccccgaggtagagaaggcggatgcaacgtttctctactcgtttgaagactctggagtgggcgatgtcaccggcttccttgctctcgacaacacgaacaaattgatcgtcctctctttccgtggctctcgttccatagagaactggatcgggaatcttaacttcgacttgaaagaaataaatgacatttgctccggctgcaggggacatgacggcttcacttcgtcctggaggtctgtagccgatacgttaaggcagaaggtggaggatgctgtgagggagcatcccgactatcgcgtggtgtttaccggacatagcttgggtggtgcattggcaactgttgccggagcagacctgcgtggaaatgggtatgatatcgacgtgttttcatatggcgccccccgagtcggaaacagggcttttgcagaattcctgaccgtacagaccggcggaacactctaccgcattacccacaccaatgatattgtccctagactcccgccgcgcgaattcggttacagccattctagcccagagtactggatcaaatctggaacccttgtccccgtcacccgaaacgatatcgtgaagatagaaggcatcgatgccaccggcggcaataaccagcctaacattccggatatccctgcgcacctatggtacttcgggttaattgggacatgtctt

SEQ ID NO: 2 - protein, 291 aa, Thermomyces lanuginosus
MRSSLVLFFVSAWTALASPIRREVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVTRNDIVKIEGIDATGGNNQPNIPDIPAHLWYFGLIGTCL

SEQ ID NO: 3 - protein, 480 aa, Bacillus amyloliquefaciens
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIY

SEQ ID NO: 4 - protein, 515 aa, Bacillus stearothermophilus
AAPFNGTMMQYFEWYLPDDGTLWTKVANEANNLSSLGITALWLPPAYKGTSRSDVGYGVYDLYDLGEFNQKGTVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGIGKAWDWEVDTENGNYDYLMYADLDMDHPEVVTELKNWGKWYVNTTNIDGFRLDAVKHIKFSFFPDWLSYVRSQTGKPLFTVGEYWSYDINKLHNYITKTDGTMSLFDAPLHNKFYTASKSGGAFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGGTEKPGSGLAALITDGPGGSKWMYVGKQHAGKVFYDLTGNRSDTVTINSDGWGEFKVNGGSVSVWVPRKTTVSTIARPITTRPWTGEFVRWTEPRLVAWP

SEQ ID NO: 5 - protein, 481 aa, Artificial Sequence
  Synthetic Construct
VNGTLMQYFEWYTPNDGQHWKRLQNDAEHLSDIGITAVWIPPAYKGTSQADVGYGAYDLYDLGEFHQKGTVRTKYGTKGELQSAIKSLHSRDINVYGDVVINHKGGADATEDVTAVEVDPADRNRVISGEHLIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNGTVVSKHPLKSVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 6 - protein, 485 aa, Bacillus sp.
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK

SEQ ID NO: 7 - protein, 485 aa, Bacillus sp. NCIB 12512
HHNGTNGTMMQYFEWYLPNDGNHWNRLRDDAANLKSKGITAVWIPPAWKGTSQNDVGYGAYDLYDLGEFNQKGTVRTKYGTRNQLQAAVTSLKNNGIQVYGDVVMNHKGGADGTEIVNAVEVNRSNRNQETSGEYAIEAWTKFDFPGRGNNHSSFKWRWYHFDGTDWDQSRQLQNKIYKFRGTGKAWDWEVDTENGNYDYLMYADVDMDHPEVIHELRNWGVWYTNTLNLDGFRIDAVKHIKYSFTRDWLTHVRNTTGKPMFAVAEFWKNDLGAIENYLNKTSWNHSVFDVPLHYNLYNASNSGGYYDMRNILNGSVVQKHPTHAVTFVDNHDSQPGEALESFVQQWFKPLAYALVLTREQGYPSVFYGDYYGIPTHGVPAMKSKIDPLLQARQTFAYGTQHDYFDHHDIIGWTREGNSSHPNSGLATIMSDGPGGNKWMYVGKNKAGQVWRDITGNRTGTVTINADGWGNFSVNGGSVSVWVKQ

SEQ ID NO: 8 - protein, 485 aa, Bacillus sp. NCIB 12513
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 9 - protein, 485 aa, Bacillus sp. 707; identical to SEQ ID NO: 6

SEQ ID NO: 10 - protein, 485 aa, Bacillus sp. A 7-7 (DSM 12368)
HHNGTNGTMMQYFEWYLPNDGNHWNRLRSDASNLKDKGITAVWIPPAWKGASQNDVGYGAYDLYDLGEFNQKGTVRTKYGTRNQLQAAVTALKSNGIQVYGDVVMNHKGGADATEWVRAVEVNPSNRNQEVSGDYTIEAWTKFDFPGRGNTHSNFKWRWYHFDGVDWDQSRQLQNRIYKFRGDGKGWDWEVDTENGNYDYLMYADIDMDHPEVVNELRNWGVWYTNTLGLDGFRIDAVKHIKYSFTRDWLTHVRNTTGKNMFAVAEFWKNDIGAIENYLSKTNWNHSVFDVPLHYNLYNASRSGGNYDMRQIFNGTVVQRHPTHAVTFVDNHDSQPEEALESFVEEWFKPLAYALTLTRDQGYPSVFYGDYYGIPTHGVPAMKSKIDPILEARQKYAYGKQNDYLDHHNMIGWTREGNTAHPNSGLATIMSDGPGGNKWMYVGRNKAGQVWRDITGNRSGTVTINADGWGNFSVNGGSVSIWVNN

SEQ ID NO: 11 - protein, 483 aa, Bacillus amyloliquefaciens
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 12 - protein, 484 aa, Bacillus sp. TS-23
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK

SEQ ID NO: 13 - protein, 485 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 14 - protein, 483 aa, Bacillus sp.
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAYTKFDFPGRGNTYSDFKWRWYHFDGVDWDQSRQFQNRIYKFRGKAWDWEVDSEFGNYDYLMYADYDMDHPEVVNELRRWGEWYTNTLNLDGFRIDAVKHIKFSFTRDWLTHVRNATGKGMFAVAEFWKNDLGALENYLNKTNWNHSVFDVPLHYNLYNASNSRGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNKGSVSIWVKR

SEQ ID NO: 15 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR